(19) United States
(12) Patent Application Publication
(10) Pub. No.: US 2024/0020577 A1
(43) Pub. Date: Jan. 18, 2024

(54) DATA MANAGEMENT SYSTEM AND DATA MANAGEMENT METHOD OF MACHINE LEARNING MODEL

(71) Applicant: Hitachi, Ltd., Tokyo (JP)

(72) Inventors: Itsumi TSUCHIYA, Tokyo (JP); Soichi TAKASHIGE, Tokyo (JP); Tatsuhiro MATSUI, Tokyo (JP)

(21) Appl. No.: 18/216,647

(22) Filed: Jun. 30, 2023

(30) Foreign Application Priority Data
Jul. 14, 2022 (JP) 2022-113074
May 19, 2023 (JP) 2023-083326

(51) Int. Cl. G06N 20/00

(52) U.S. Cl. CPC G06N 20/00

(57) ABSTRACT

In a data management system of a machine learning model, flag management information (a flag importance management table) manages and defines respective flags corresponding to, of a plurality of processes included in the life cycle, one or more predetermined processes. An operation unit assigns flags defined in the flag management information to input data and output data of the model in accordance with involvement in the predetermined processes when the model is operated. A data management unit determines, with respect to each of the input data and the output data, the necessity of storage of data on the basis of a flag assigned to the data by the operation unit.

### CROSS-REFERENCE TO RELATED APPLICATION

The present application claims priority from Japanese applications JP2022-113074, filed on Jul. 14, 2022, and JP2023-083326 filed May 19, 2023, the contents of which are hereby incorporated by reference into this application.

### BACKGROUND OF THE INVENTION

### 1. Field of the Invention

The present invention relates to a data management system and a data management method of a machine learning model, and is suitable to be applied to a past-results-data management system and a past-results-data management method of a machine learning model that supports determination of the necessity of input/output data of machine learning in accordance with the life cycle of machine learning.

### 2. Description of the Related Art

In machine learning, to maintain or improve the accuracy of a model, it is effective to repeat the life cycle including inference and evaluation. At this time, it is necessary to accumulate data at the time of inference and monitor and analyze the accumulated data, and there is increasing demand for a platform to provide these functions.

Regarding the life cycle of machine learning, for example, JP 2021-60940 A discloses an operation support system using machine learning that supports repeating the training of a model generated from input data and replacing the model with a higher-accuracy one.

### SUMMARY OF THE INVENTION

However, the above-described conventional technology does not devise an operation considering whether or not input data and output data of a model of machine learning are data necessary for the subsequent machine learning. As a result, as the life cycle rotates, data is accumulated, which causes a problem that the running cost of the system increases.

The present invention has been made in view of the above points, and is intended to propose a data management system and a data management method of a machine learning model capable of efficiently operating deletion of unnecessary data.

To solve the problem, the present invention provides a data management system of a machine learning model that manages a model and its associated data while operating the model along the life cycle of machine learning, the data management system including: flag management information that manages and defines respective flags corresponding to, of a plurality of processes included in the life cycle, one or more predetermined processes; an operation unit that operates the model along the life cycle; and a data management unit that manages input data and output data of the model, in which the operation unit assigns flags defined in the flag management information to the input data and the output data of the model in accordance with involvement in the predetermined processes at time of operating the model, and the data management unit determines, with respect to each of the input data and the output data, necessity of storage of data on the basis of a flag assigned to the data by the operation unit.

Furthermore, to solve the problem, the present invention provides a data management method implemented by a data management system of a machine learning model that manages a model and its associated data while operating the model along the life cycle of machine learning, the data management system including: flag management information that manages and defines respective flags corresponding to, of a plurality of processes included in the life cycle, one or more predetermined processes; an operation unit that operates the model along the life cycle; and a data management unit that manages input data and output data of the model, and
the data management method including:
an operation step in which the operation unit assigns flags defined in the flag management information to the input data and the output data of the model in accordance with involvement in the predetermined processes at time of operating the model; and
a necessity determination step in which the data management unit determines, with respect to each of the input data and the output data, necessity of storage of data on a basis of a flag assigned to the data at the operation step.

According to the present invention, it is possible to efficiently operate deletion of unnecessary data in data management of a machine learning model.

### BRIEF DESCRIPTION OF THE DRAWINGS

FIG. 1 is a block diagram showing a configuration example of a data management system 1 according to an embodiment of the present invention;

FIG. 2 is a diagram showing an example of a data management table 31;

FIG. 3 is a diagram showing an example of a flag importance management table 32;

FIG. 4 is a diagram showing an example of a retraining likelihood management table 33;

FIG. 5 is a diagram showing an example of a retraining likelihood history management table 34;

FIG. 6 is a diagram showing an example of a monitoring screen management table 35;

FIG. 7 is a diagram showing an example of a monitoring screen history management table 36;

FIG. 8 is a diagram showing an example of a training process management table 37;

FIG. 9 is a diagram showing an example of an evaluation process management table 38;

FIG. 10 is a flowchart showing an example of the processing procedure of the whole process;

FIG. 11 is a flowchart showing an example of the processing procedure of a data input process;

FIG. 12 is a flowchart showing an example of the processing procedure of a training process;

FIG. 13 is a diagram showing an example of a monitoring screen 110;

FIG. 14 is a diagram showing an example of a retraining screen 120;

FIG. 15 is a flowchart showing an example of the processing procedure of an evaluation process;

FIG. 16 is a diagram showing an example of an evaluation screen 130;

FIG. 17 is a flowchart showing an example of the processing procedure of a model update process;

FIG. 18 is a flowchart showing an example of the processing procedure of a data management process;

FIG. 19 is a flowchart showing an example of the processing procedure of a result display process;

FIG. 20 is a diagram showing an example of a data management result screen 140;

FIG. 21 is a block diagram showing a configuration example of a data management system that is a modification example of the data management system;

FIG. 22 is a diagram showing an example of a data management table;

FIG. 23 is a diagram showing an example of a flag importance management table;

FIG. 24 is a diagram showing an example of an incident management table;

FIG. 25 is a diagram showing an example of a false positive management table;

FIG. 26 is a flowchart showing an example of the processing procedure of an incident collection process; and

FIG. 27 is a flowchart showing an example of the processing procedure of an incident evaluation process.

### DESCRIPTION OF THE PREFERRED EMBODIMENT

An embodiment of the present invention will be described in detail below with reference to drawings.

It is noted that the following description and the drawings are examples for explaining the present invention, and, for clarification of the description, they are partially omitted or simplified accordingly. Furthermore, all of combinations of characteristics described in the embodiment are not necessarily essential means for solving the problem. The present invention is not limited to the embodiment, and all application examples consistent with the concept of the present invention are included in the technical scope of the present invention. Various additions, modifications, etc. can be made by those skilled in the art within the scope of the present invention. The present invention can be embodied in various other forms. Unless otherwise defined, each component may be plural or singular.

In the following description, a variety of information may be described in forms of representation such as a “table”, a “chart”, a “list”, and a “queue”; however, besides these, a variety of information may be represented by a data structure. To show that it does not depend on a data structure, an “XX table”, an “XX list”, or the like may be referred to as “XX information”. When contents of each piece of information are described, the terms such as “identification information”, “identifier”, “name”, “ID”, and “number” are used; these can be replaced with one another.

Furthermore, in the following description, there is a case where a process performed by executing a program is described; the program is executed by at least one or more processors (for example, CPUs), and thus a predetermined process is performed using a storage resource (for example, a memory) and/or an interface device (for example, a communication port) accordingly, and therefore, the subject of the process may be the processor(s). Likewise, the subject of the process performed by executing the program may be a controller, a device, a system, a computer, a node, a storage system, a storage device, a server, a management computer, a client, or a host that includes the processor(s). The subject (for example, the processor(s)) of the process performed by executing the program may include a hardware circuit that performs some or all of the process. For example, the subject of the process performed by executing the program may include a hardware circuit that performs encryption and decryption or compression and decompression. The processor operates in accordance with the program, and thereby operates as a functional unit that realizes a predetermined function. A device and a system that include the processor are a device and a system that include this functional unit.

The program may be installed in a device such as a computer from a program source. The program source may be, for example, a program distribution server or a computer-readable storage medium. In a case where the program source is a program distribution server, the program distribution server includes a processor (for example, a CPU) and a storage resource, and the storage resource may further store therein a distribution program and a program to be distributed. Then, the processor of the program distribution server may be configured to execute the distribution program, thereby distributing the program to be distributed to other computers. Furthermore, in the following description, two or more programs may be realized as one program, or one program may be realized as two or more programs.

(1) System Configuration

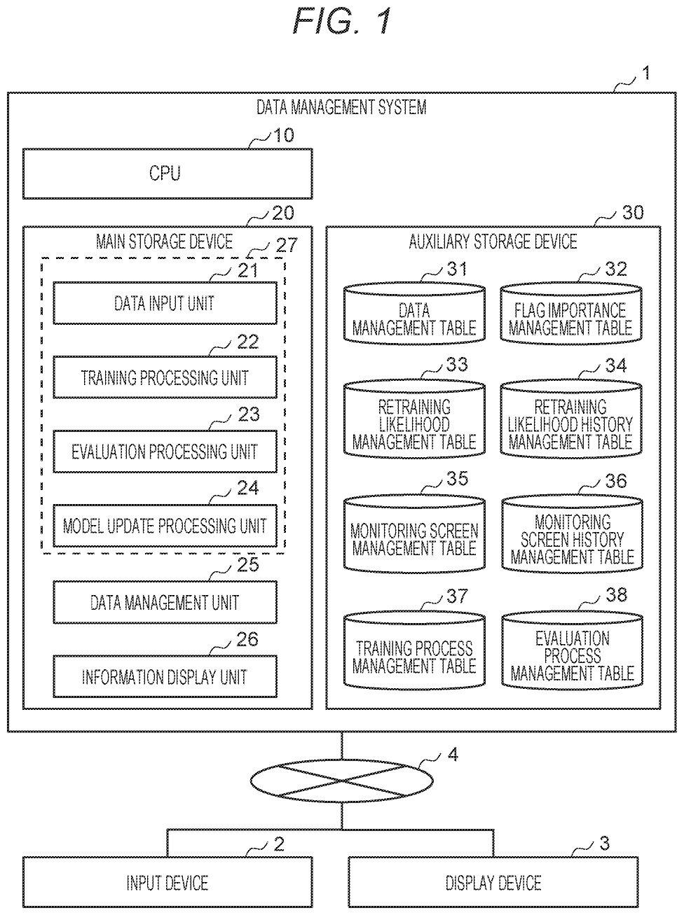

FIG. 1 is a block diagram showing a configuration example of a data management system 1 according to an embodiment of the present invention. The data management system 1 is a computer including a CPU 10, a main storage device 20, and an auxiliary storage device 30. In a case of FIG. 1, an input device 2 and a display device 3 are connected to the outside of the data management system 1 via a network 4; however, the input device 2 and the display device 3 may be components included in the data management system 1.

The CPU 10 is an example of a processor; the processor is not limited to a central processing unit (CPU), and may be a graphics processing unit (GPU) or the like.

The main storage device 20 is a memory such as a dynamic RAM (DRAM), and stores therein a program and data. FIG. 1 shows a configuration in which the main storage device 20 includes a data input unit 21, a training processing unit 22, an evaluation processing unit 23, a model update processing unit 24, a data management unit 25, and an information display unit 26. Respective functions of these functional units 21 to 26 are realized by the CPU 10 reading a program into the main storage device 20 (the memory) and executing the program. The program body is stored in the main storage device 20 or another storage device such as the auxiliary storage device 30. Details of the functions provided by the functional units 21 to 26 (processes executed by the program) will be described later with reference to the drawings. It is noted that the above-described functional unit 21 to 24 have functions of operating a model along the life cycle of machine learning, and therefore these are collectively referred to as an operation unit 27.

Specifically, the auxiliary storage device 30 is a storage device such as a hard disk drive (HDD) or a solid state drive (SSD); however, the auxiliary storage device 30 is not limited to these, and a cloud or the like may be used. According to FIG. 1, a data management table 31, a flag importance management table 32, a retraining likelihood management table 33, a retraining likelihood history management table 34, a monitoring screen management table 35, a monitoring screen history management table 36, a training process management table 37, and an evaluation process management table 38 are stored in the auxiliary storage device 30. Details of the management tables 31 to 38 will be described later with reference to the drawings. Furthermore, the auxiliary storage device 30 stores a model used by the data management system 1 in a model storage unit (not shown).

The input device 2 is an input device manipulated by a user. Specifically, the input device 2 is, for example, a mouse, a keyboard, etc.

The display device 3 is an output device used by the user. Specifically, the display device 3 is, for example, a display. The display device 3 displays thereon various display screens (a monitoring screen 110, a retraining screen 120, an evaluation screen 130, and a data management result screen 140 to be described later) generated by the information display unit 26. It is noted that the output format of information from the data management system 1 in the present embodiment is not limited to display, and various commonly-known output formats, such as data output to a recording medium and printing, can be adopted.

(2) Data Configuration

The various management tables 31 to 38 held by the auxiliary storage device 30 are described in detail below with a specific example.

(2-1) Data Management Table 31

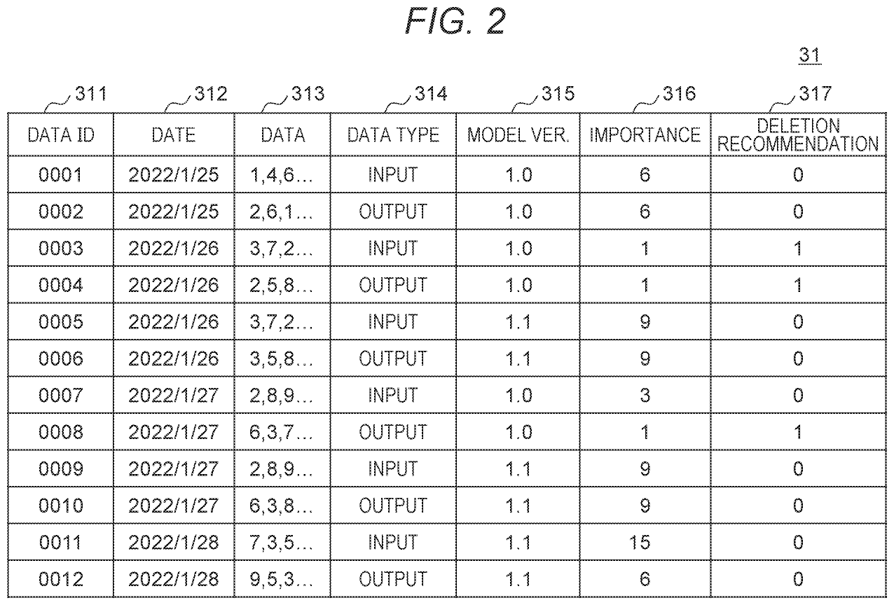

FIG. 2 is a diagram showing an example of the data management table 31. The data management table 31 is information to manage input/output data of a model of machine learning. The data management table 31 shown in FIG. 2 includes items of data ID 311, date 312, data 313, data type 314, model version (Model Ver.) 315, importance 316, and deletion recommendation 317, and the data ID 311 is a primary key.

The data ID 311 is an identifier that can identify input/output data (referred to as “the data” in the description of FIG. 2 below) managed in a corresponding record, and a different ID is assigned to each data held by the data management system 1. The date 312 indicates the date the data has been generated (It may indicate the date and time). The data 313 indicates the data itself such as an actual measured value. The data type 314 indicates a type of the data; specifically, it is “input” in a case where the data is input data, and “output” in a case where the data is output data. The model version 315 indicates a version of a model of which the data is input or output.

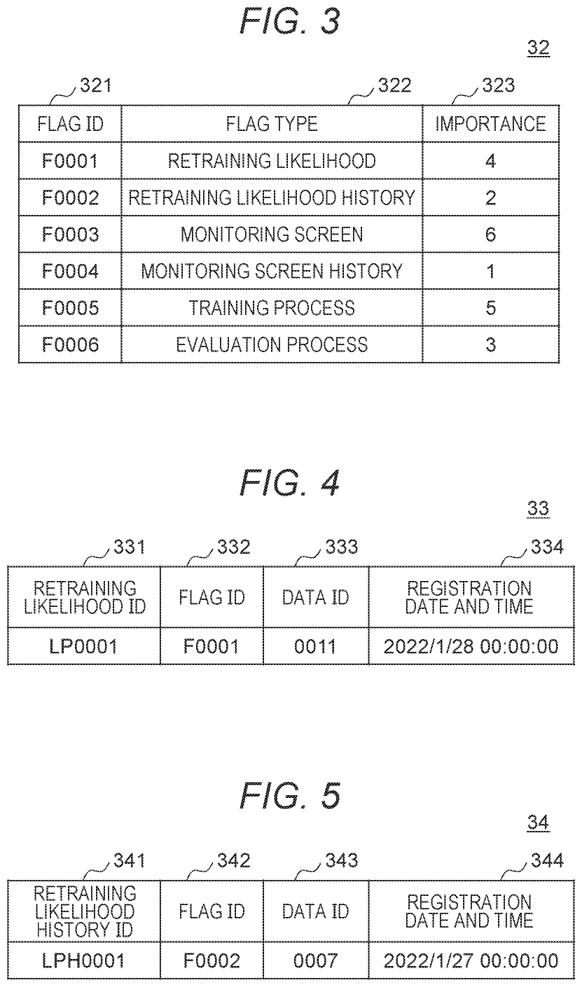

The importance 316 indicates a degree of importance as data held by the data management system 1 based on a flag assigned to the data. A larger numerical value is registered with respect to more important one as data to be held, and a smaller numerical values is registered with respect to less important one. In the data management system 1 according to the present embodiment, in accordance with a process in which the data may be involved (i.e., what process the data has been used in or what process the data may be used in) in rotating the life cycle of machine learning, each piece of input/output data is assigned a flag (a flag ID) corresponding to the process. As shown in the flag importance management table 32 of FIG. 3 to be described later, each flag (a flag ID 321) is associated with importance 323, and a value registered in importance 316 is calculated on the basis of a degree of importance 323 of a flag assigned to the data. Specifically, for example, respective degrees of importance 323 of all flags assigned to the data may be added up and set as importance 316; besides this, for example, of the degrees of importance 323 of the flags assigned to the data, importance 323 having the largest value may be selected and set as importance 316.

The deletion recommendation 317 indicates a value of evaluation of whether or not deletion of the data is recommended. The evaluation value stored in the deletion recommendation 317 is determined on the basis of the importance 316 of the data; however, a method of this determination is not limited to a particular method. In this example, in a case where the importance 316 of the data is equal to or lower than a predetermined threshold, “1” indicating that deletion of the data is recommended is stored; in a case where the importance 316 of the data exceeds the predetermined threshold, “0” indicating that deletion of the data is not recommended is stored. As a variation of the determination method, phased thresholds may be provided, and the level (the evaluation value) of deletion recommendation may be calculated in several phases.

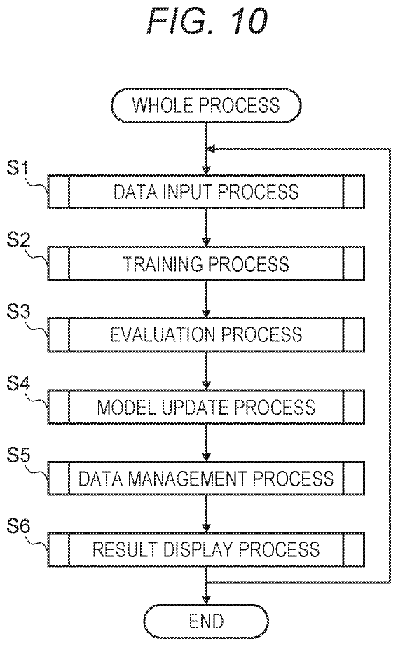

The value of each item of the data management table 31 described above is appropriately registered or updated in units of records during execution of a data input process (step S1 in FIG. 10), an evaluation process (step S3 in FIG. 10), and a data management process (step S5 in FIG. 10).

(2-2) Flag Importance Management Table 32

FIG. 3 is a diagram showing an example of the flag importance management table 32. The flag importance management table 32 is information to manage the importance of a flag. As described in the importance 316 of FIG. 2, a flag is assigned to each piece of input/output data in accordance with a process in which the input/output data may be involved in rotating the life cycle of machine learning. Therefore, a plurality of flags may be assigned to one piece of input data or output data. The flag importance management table 32 shown in FIG. 3 includes items of flag ID 321, flag type 322, and importance 323, and the flag ID 321 is a primary key.

The flag ID 321 is an identifier that can identify a flag (referred to as “the flag” in the description of FIG. 3 below) managed in a corresponding record, and a different ID is assigned to each flag. The flag type 322 indicates a name of the flag. In a case of FIG. 3, a name of a process or a result display screen in which input/output data that is assigned the flag is involved (or may be involved) is used as a value of the flag type 322; alternatively, with respect to the involved process or result display screen, a flag may be set in several phases.

The importance 323 indicates the priority of data that has been assigned the flag to be maintained (i.e., to not be deleted) in the data management system 1. The higher the degree of importance 323 is, the more important the flag is, which means that input/output data that has been assigned the flag should be maintained (should not be deleted) in the data management system 1.

The value of each item of the flag importance management table 32 described above is registered in advance in units of records. Furthermore, after the value has been registered in each item of the flag importance management table 32, change of the importance 323, addition or deletion of a flag (a record), etc. can be made as necessary. Moreover, types of flags managed in the flag importance management table 32 are not limited to the above example.

(2-3) Retraining Likelihood Management Table 33

FIG. 4 is a diagram showing an example of the retraining likelihood management table 33. The retraining likelihood management table 33 is information to manage data likely to be subjected to a training process (step S2 in FIG. 10) (data having a likelihood of retraining) hereafter. In the present embodiment, when output data is generated from a model using a certain piece of input data, in a case where an abnormality is detected in the output data or in a case where the rarity of the input data is high, the input data is determined to be data having a likelihood of retraining. The retraining likelihood management table 33 shown in FIG. 4 includes items of retraining likelihood ID 331, flag ID 332, data ID 333, and registration date and time 334, and the retraining likelihood ID 331 is a primary key.

The retraining likelihood ID 331 is an identifier that can identify data managed in a corresponding record, and a different ID is assigned to each data having a likelihood of retraining. The flag ID 332 indicates an ID of a flag related to a retraining likelihood based on the flag ID 321 of the flag importance management table 32 of FIG. 3. Specifically, the flag ID 321 of a record of which the flag type 322 is “retraining likelihood” in the flag importance management table 32 of FIG. 3 is “F0001”, and this “F0001” is registered in the flag ID 332. Since data having a likelihood of being used in retraining is data assumed to be better not to be deleted from the data management system 1 (if deleted, it cannot be used in retraining), a relatively high degree of importance of “4” is set to the flag “F0001” assigned to the data managed in the retraining likelihood management table 33 (see FIG. 3). The data ID 333 indicates an identifier (a data ID 311) assigned to data managed in the record on the basis of the data management table 31 of FIG. 2. The registration date and time 334 indicates the date and time the record (the data having a likelihood of retraining) has been registered in the retraining likelihood management table 33.

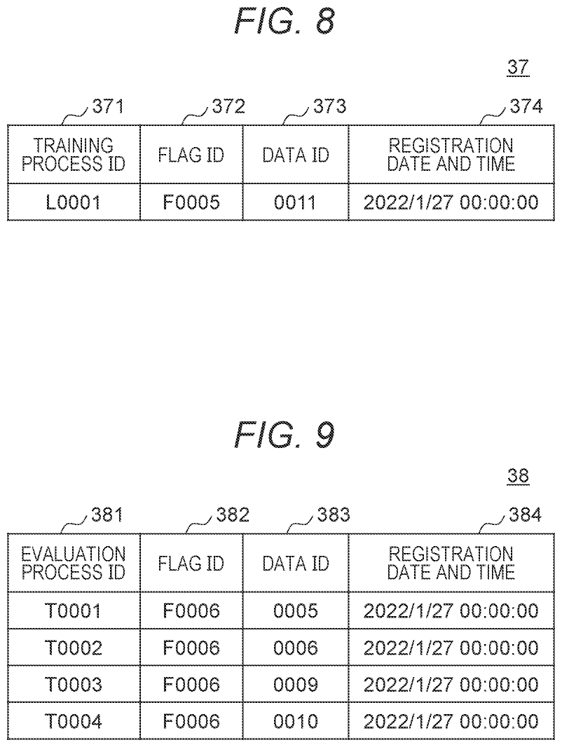

The value of each item of the retraining likelihood management table 33 described above is registered in units of records in a data input process (step S1 in FIG. 10), and, in a case where registered data is used in a training process (step S2 in FIG. 10), its record is deleted in the training process. Then, the data of which the record has been deleted from the retraining likelihood management table 33 is registered in the retraining likelihood history management table 34 shown in FIG. 5 and the training process management table 37 shown in FIG. 8.

(2-4) Retraining Likelihood History Management Table 34

FIG. 5 is a diagram showing an example of the retraining likelihood history management table 34. The retraining likelihood history management table 34 is information to manage data (input data) used in a training process after registered in the retraining likelihood management table 33. The retraining likelihood history management table 34 shown in FIG. 5 includes items of retraining likelihood history ID 341, flag ID 342, data ID 343, and registration date and time 344, and the retraining likelihood history ID 341 is a primary key.

The retraining likelihood history ID 341 is an identifier that can identify data managed in a corresponding record, and a different ID is assigned to each input data used in a training process (used in retraining) after registered in the retraining likelihood management table 33. The flag ID 342 indicates an ID of a flag related to a retraining likelihood history based on the flag ID 321 of the flag importance management table 32 of FIG. 3. Specifically, the flag ID 321 of a record of which the flag type 322 is “retraining likelihood history” in the flag importance management table 32 of FIG. 3 is “F0002”, and this “F0002” is registered in the flag ID 342. Since retraining likelihood data after used in retraining is considered to be not so high in importance after that, a relatively low degree of importance of “2” is set to the flag “F0002” assigned to the data managed in the retraining likelihood history management table 34 (see FIG. 3). The data ID 343 indicates an identifier (a data ID 311) assigned to data managed in the record on the basis of the data management table 31 of FIG. 2. The registration date and time 344 indicates the date and time the record (the retrained data) has been registered in the retraining likelihood history management table 34.

In a case where data registered in the retraining likelihood management table 33 is used in a training process (step S2 in FIG. 10), the value of each item of the retraining likelihood history management table 34 described above is registered in units of records in the training process.

(2-5) Monitoring Screen Management Table 35

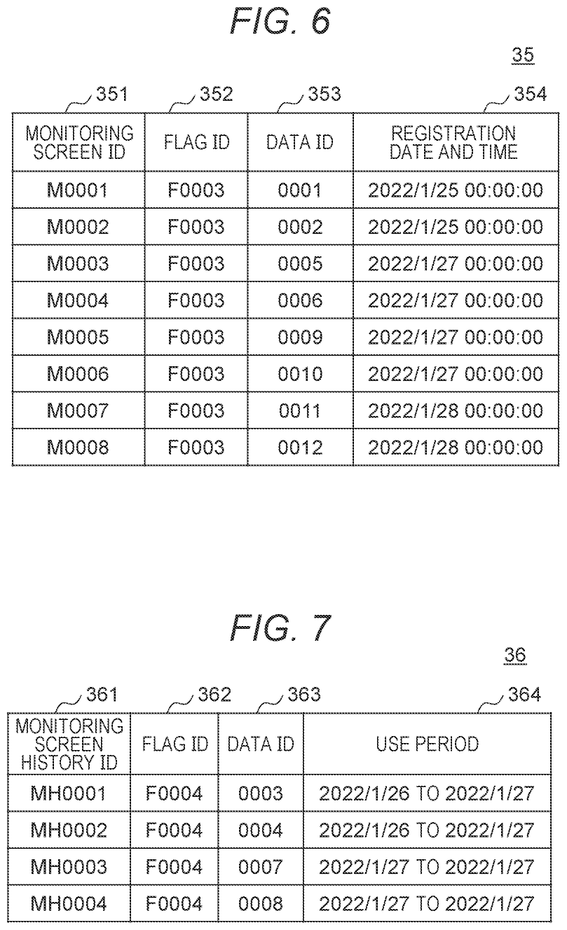

FIG. 6 is a diagram showing an example of the monitoring screen management table 35. The monitoring screen management table 35 is information to manage data displayed on a monitoring screen. The monitoring screen management table 35 shown in FIG. 6 includes items of monitoring screen ID 351, flag ID 352, data ID 353, and registration date and time 354, and the monitoring screen ID 351 is a primary key.

The monitoring screen ID 351 is an identifier that can identify data managed in a corresponding record, and a different ID is assigned to each data displayed on the monitoring screen. The flag ID 352 indicates an ID of a flag related to the monitoring screen based on the flag ID 321 of the flag importance management table 32 of FIG. 3. Specifically, the flag ID 321 of a record of which the flag type 322 is “monitoring screen” in the flag importance management table 32 of FIG. 3 is “F0003”, and this “F0003” is registered in the flag ID 352. Since the data displayed on the monitoring screen is data that must not be deleted from the data management system 1 (if deleted, it cannot be displayed on the monitoring screen), the highest degree of importance of “6” is set to the flag “F0003” assigned to the data managed in the monitoring screen management table 35 (see FIG. 3). The data ID 353 indicates an identifier (a data ID 311) assigned to data managed in the record on the basis of the data management table 31 of FIG. 2. The registration date and time 354 indicates the date and time the record (the data displayed on the monitoring screen) has been registered in the monitoring screen management table 35.

The value of each item of the monitoring screen management table 35 described above is registered in units of records in a model update process (step S4 in FIG. 10). Furthermore, in a case where a new model version of data has been registered in the monitoring screen management table 35 in a model update process, a record of, of the data registered in the monitoring screen management table 35, data (an old version of data) having the same date (period) as the newly registered data and a model version different from that of the newly registered data is deleted. Then, the data of which the record has been deleted from the monitoring screen management table 35 is registered in the monitoring screen history management table 36 shown in FIG. 7.

(2-6) Monitoring Screen History Management Table 36

FIG. 7 is a diagram showing an example of the monitoring screen history management table 36. The monitoring screen history management table 36 is information to manage data that had once been displayed on the monitoring screen. The monitoring screen history management table 36 shown in FIG. 7 includes items of monitoring screen history ID 361, flag ID 362, data ID 363, and use period 364, and the monitoring screen history ID 361 is a primary key.

The monitoring screen history ID 361 is an identifier that can identify data managed in a corresponding record, and a different ID is assigned to each data displayed on the monitoring screen. The flag ID 362 indicates an ID of a flag related to a monitoring screen history based on the flag ID 321 of the flag importance management table 32 of FIG. 3. Specifically, the flag ID 321 of a record of which the flag type 322 is “monitoring screen history” in the flag importance management table 32 of FIG. 3 is “F0004”, and this “F0004” is registered in the flag ID 362. Since data after used in display of the monitoring screen is considered to be not high in importance after that, the lowest degree of importance of “1” is set to the flag “F0004” assigned to the data managed in the monitoring screen history management table 36 (see FIG. 3). The use period 364 indicates a period in which the data has been displayed on the monitoring screen.

In a case where there is data deleted from the monitoring screen management table 35 in a model update process (step S4 in FIG. 10), with respect to the data, the value of each item of the monitoring screen history management table 36 is registered in units of records in the model update process.

(2-7) Training Process Management Table 37

FIG. 8 is a diagram showing an example of the training process management table 37. The training process management table 37 is information to manage data (input data that has been retrained in the past) used in a training process (step S2 in FIG. 10) to be described later. The training process management table 37 shown in FIG. 8 includes items of training process ID 371, flag ID 372, data ID 373, and registration date and time 374, and the training process ID 371 is a primary key.

The training process ID 371 is an identifier that can identify data managed in a corresponding record, and a different ID is assigned to each input data used in a training process. The flag ID 372 indicates an ID of a flag related to a training process based on the flag ID 321 of the flag importance management table 32 of FIG. 3. Specifically, the flag ID 321 of a record of which the flag type 322 is “training process” in the flag importance management table 32 of FIG. 3 is “F0005”, and this “F0005” is registered in the flag ID 372. Since data that has been used in training (retraining) in the past is highly likely to be referenced in after-the-fact verification, etc. and is high in importance, a relatively high degree of importance of “5” is set to the flag “F0005” assigned to the data managed in the training process management table 37 (see FIG. 3). The data ID 373 indicates an identifier (a data ID 311) assigned to data managed in the record on the basis of the data management table 31 of FIG. 2. The registration date and time 374 indicates the date and time the record (the input data used in the training) has been registered in the training process management table 37.

The value of each item of the training process management table 37 described above is registered in units of records in a training process (step S2 in FIG. 10).

(2-8) Evaluation Process Management Table 38

FIG. 9 is a diagram showing an example of the evaluation process management table 38. The evaluation process management table 38 is information to manage output data used in an evaluation process (step S3 in FIG. 10) to be described later. The evaluation process management table 38 shown in FIG. 9 includes items of evaluation process ID 381, flag ID 382, data ID 383, and registration date and time 384, and the evaluation process ID 381 is a primary key.

The evaluation process ID 381 is an identifier that can identify data managed in a corresponding record, and a different ID is assigned to each output data evaluated in an evaluation process. The flag ID 382 indicates an ID of a flag related to an evaluation process based on the flag ID 321 of the flag importance management table 32 of FIG. 3. Specifically, the flag ID 321 of a record of which the flag type 322 is “evaluation process” in the flag importance management table 32 of FIG. 3 is “F0006”, and this “F0006” is registered in the flag ID 382. Since data that has been evaluated in the past is likely to be referenced in after-the-fact verification, etc. and is assumed to have a medium degree of importance, a medium degree of importance of “3” is set to the flag “F0006” assigned to the data managed in the evaluation process management table 38 (see FIG. 3). The data ID 383 indicates an identifier (a data ID 311) assigned to data managed in the record on the basis of the data management table 31 of FIG. 2. The registration date and time 384 indicates the date and time the record (the evaluated output data) has been registered in the evaluation process management table 38.

The value of each item of the evaluation process management table 38 described above is registered in units of records in an evaluation process (step S3 in FIG. 10).

(3) Processes

As for processes performed by the data management system 1 according to the present embodiment, first, the whole process, and then details of each process constituting the whole process will be described below.

(3-1) Whole Process

FIG. 10 is a flowchart showing an example of the processing procedure of the whole process. The whole process shown in FIG. 10 is the overall process performed by the data management system 1 regarding machine learning of data.

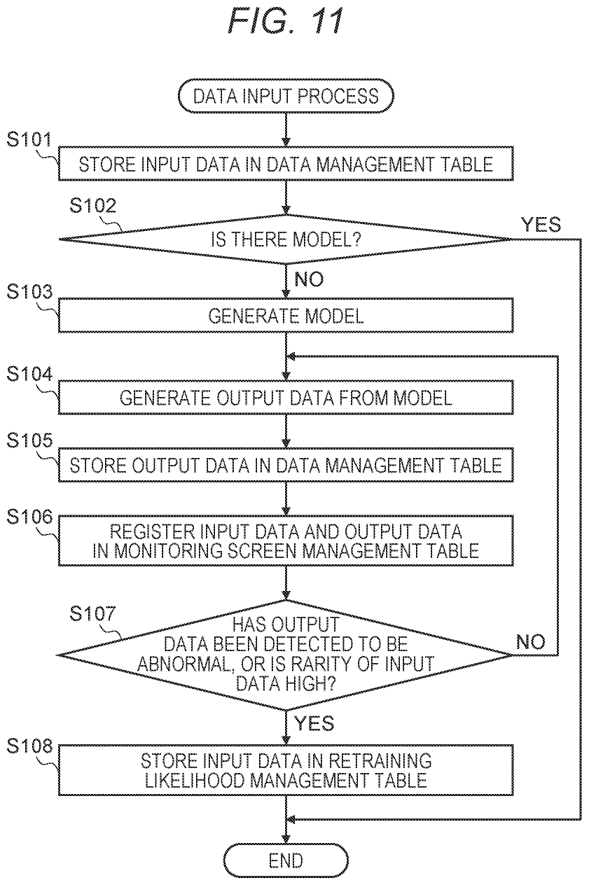

According to FIG. 10, first, the data input unit 21 generates output data from a model, and performs a data input process of registering input/output data in the data management table 31 (step S1). Although the details will be described later with reference to FIG. 11, the data input process includes a process of storing input/output data in the data management table 31, a process of generating a model, a process of generating output data from the model, a process of registering data in the monitoring screen management table 35, and a process of registering data in the retraining likelihood management table 33.

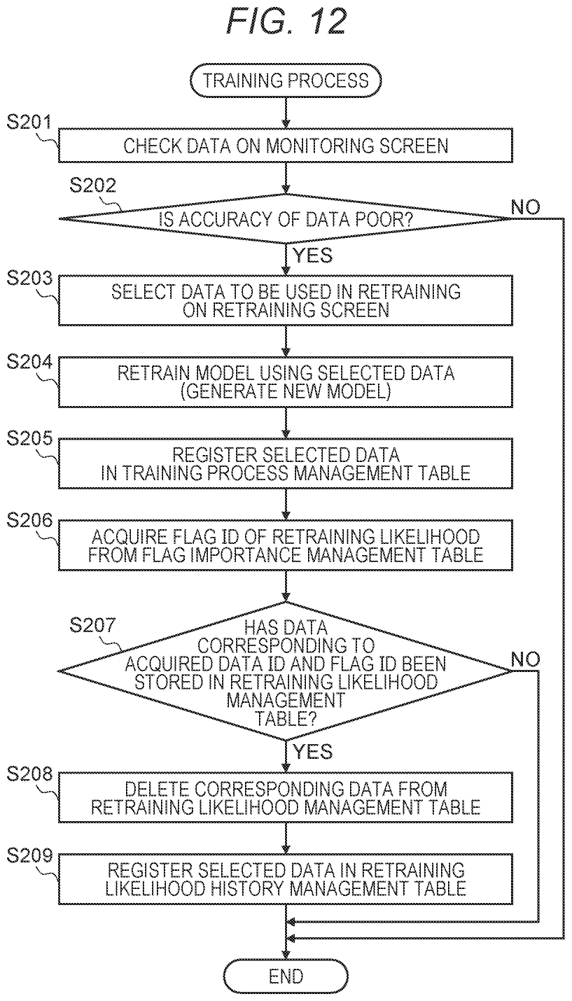

Next, the training processing unit 22 performs a training process of retraining the model in a case where the accuracy of the output data generated in the data input process is poor (step S2). Although the details will be described later with reference to FIG. 12, the training process includes, in a case where it is not yet trained, or in a case where the accuracy of the output data generated in step S1 is poor, a process of generating a new model using selected data, a process of storing data in the training process management table 37, a process of deleting data from the retraining likelihood management table 33, and a process of registering data in the retraining likelihood history management table 34.

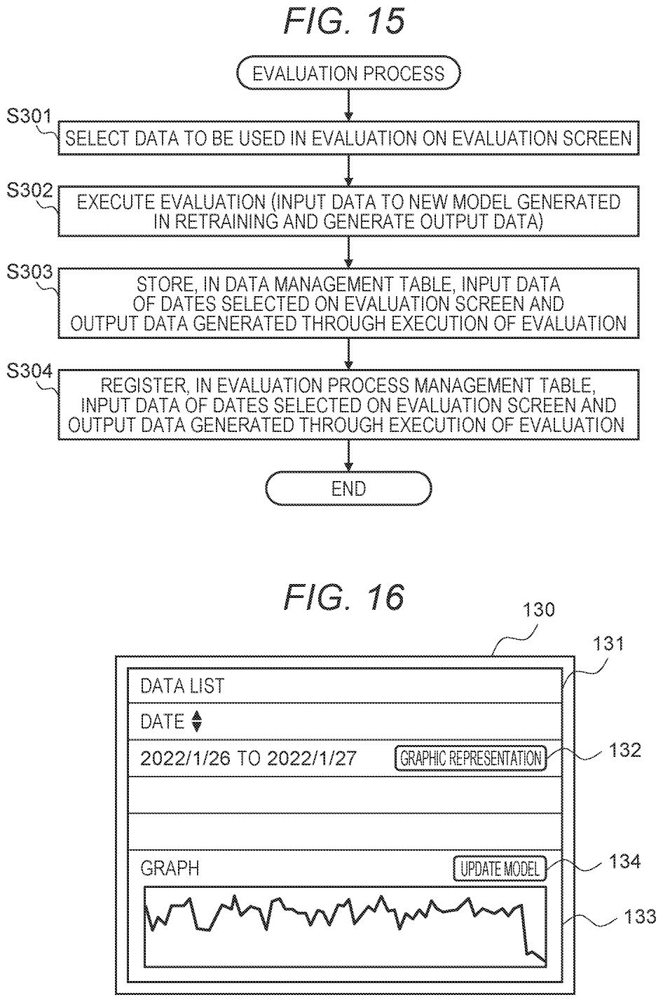

Next, the evaluation processing unit 23 generates output data from the new model generated in step S2, and performs an evaluation process of evaluating this output data (step S3). Although the details will be described later with reference to FIG. 15, the evaluation process includes a process of generating output data from a new model, a process of storing input data and output data in the data management table 31, and a process of registering data in the evaluation process management table 38.

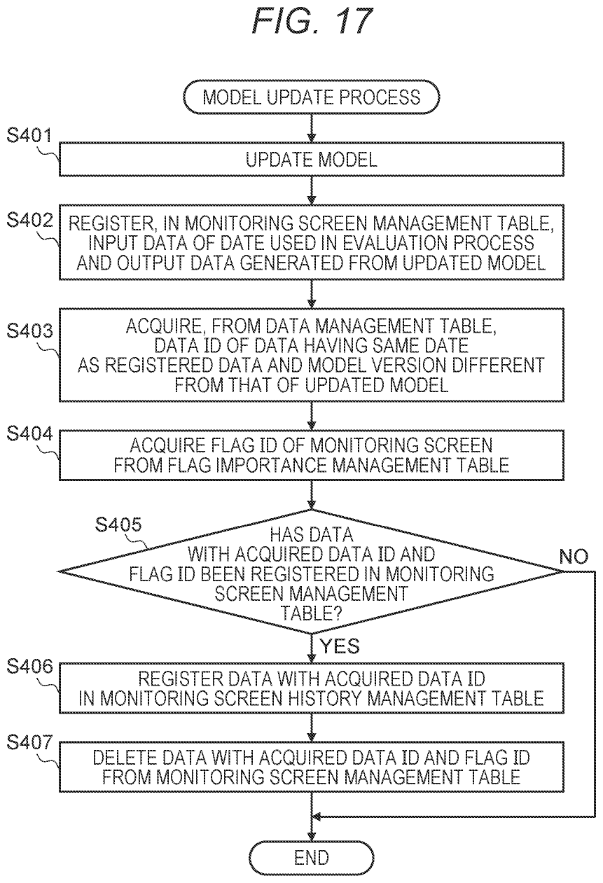

Next, in a case where the accuracy of the output data generated in the evaluation process of step S3 is excellent, the model update processing unit 24 performs a model update process of updating the model to be used (step S4). Although the details will be described later with reference to FIG. 17, the model update process includes a process of updating the model to be used to an evaluated model, a process of registering data in the monitoring screen management table 35, a process of deleting data from the monitoring screen management table 35, and a process of registering data in the monitoring screen history management table 36.

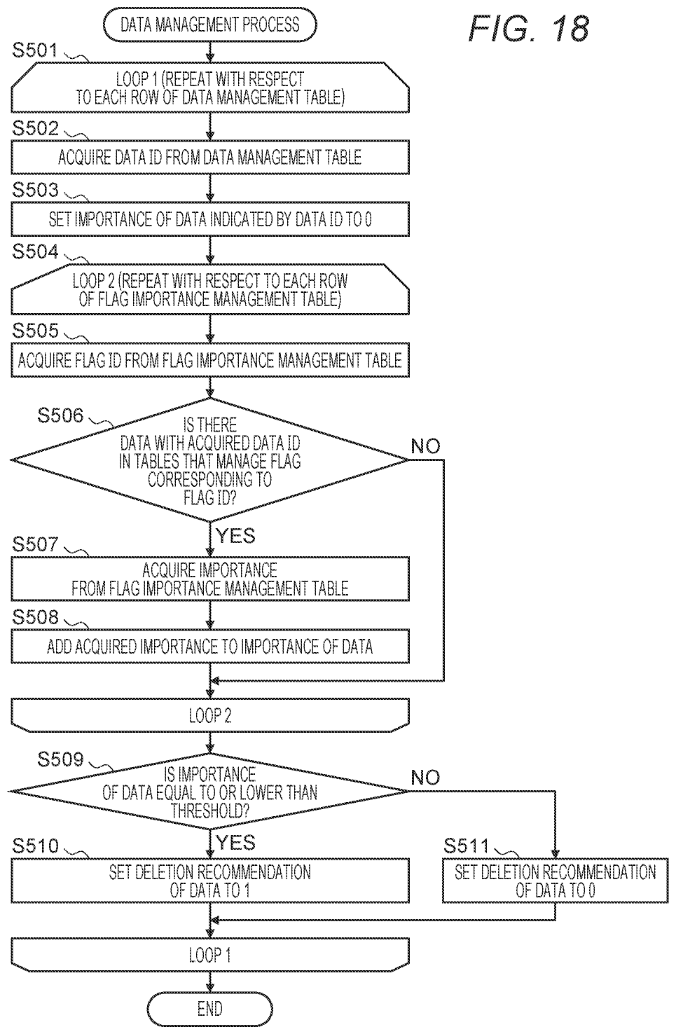

Next, the data management unit 25 performs a data management process of calculating the importance of each data on the basis of a flag assigned to the data in the processes of steps S1 to S4, determining whether the data is data of which the deletion is recommended, and storing the data in the data management table 31 (step S5). Although the details will be described later with reference to FIG. 18, the data management process includes a process of acquiring a flag assigned to each data, a process of calculating a degree of importance of data on the basis of a degree of importance of a flag, and a process of determining data of which the deletion is recommended on the basis of a degree of importance of the data and registering a result of the determination in the data management table 31.

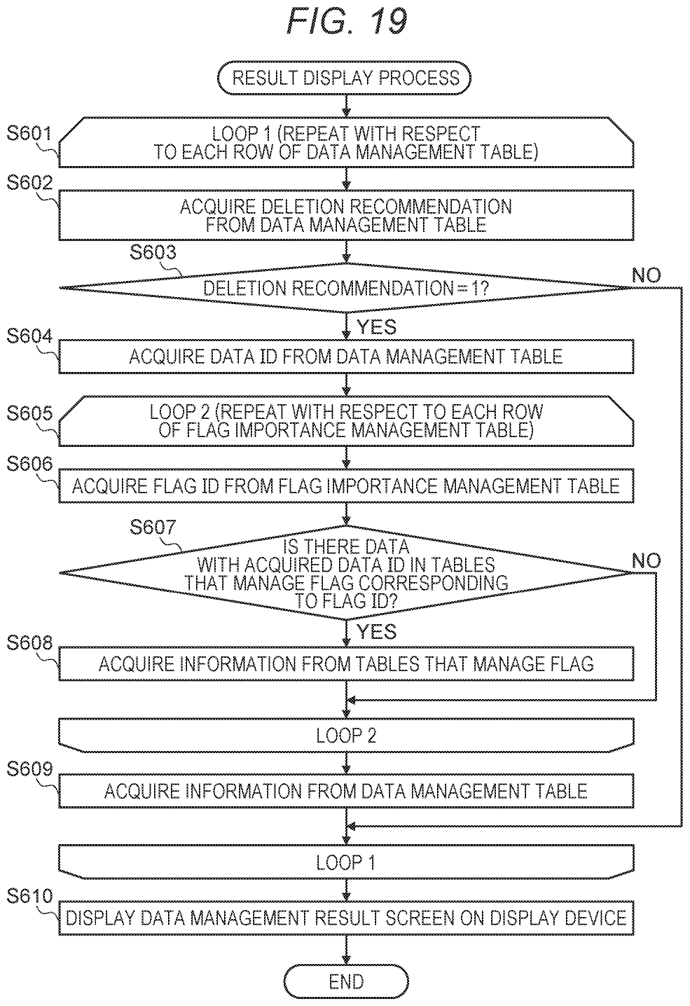

Last, the information display unit 26 performs a result display process of displaying the data management result screen 140 showing the result of the determination of deletion recommendation determined in the data management process of step S5 on the display device 3 (step S6). Although the details will be described later with reference to FIG. 19, the result display process includes a process of acquiring and displaying the information registered in the data management table 31 in steps S1 to S5.

Machine learning can maintain or improve the accuracy of a model by repeating the life cycle; therefore, after the process in step S6, it is preferable to return to step S1 and repeatedly perform the processes of steps S1 to S6. However, in the data management system 1 according to the present embodiment, the result display process of step S6 does not necessarily have to be performed each time a series of the processes of steps S1 to S5 is performed. Specifically, for example, in a case where a user operation to request display of information regarding deletion recommendation data has been made while a series of the processes of steps S1 to S5 is performed in a regular or irregular loop, the process of step S6 may be performed after step S5 of the latest loop processing at that time.

(3-2) Data Input Process

FIG. 11 is a flowchart showing an example of the processing procedure of the data input process. The data input process shown in FIG. 11 corresponds to the process of step S1 in FIG. 10, and is performed by the data input unit 21.

According to FIG. 11, first, the data input unit 21 stores input data such as an actual measured value in the data management table 31 (step S101). At this time, in the data management table 31, a record related to the input data is newly created, and respective values of the items of data ID 311, date 312, data 313, and data type 314 in the record are registered. A value of the item of model version 315 may be registered at the predetermined timing after step S101. For example, in a case where there is a model in step S102 to be described later, it is only necessary to register the model version of the model only; in a case where there is no model in step S102, it is only necessary to register the model version of a model generated in step S103. It is noted that respective values of the items of importance 316 and deletion recommendation 317 are registered in the data management process.

Next, the data input unit 21 checks whether there is a model in the auxiliary storage device 30 (step S102). In a case where there is a model in step S102 (YES in step S102), the data input unit 21 ends the data input process.

In a case where there is no model in step S102 (NO in step S102), the data input unit 21 generates a model on the basis of the input data stored in the data management table 31 in step S101 (step S103).

Next, the data input unit 21 generates output data from the model generated in step S103 with the input data in step S101 as an input (step S104), and registers the generated output data in the data management table 31 (step S105). At this time, in the data management table 31, a record related to the output data is newly created, and respective values of the items of data ID 311, date 312, data 313, data type 314, and model version 315 in the record are registered. It is noted that respective values of the items of importance 316 and deletion recommendation 317 are registered in the data management process.

Next, the data input unit 21 registers the input data and the output data in the monitoring screen management table 35 (step S106). At this time, in the monitoring screen management table 35, a record is newly created with respect to each of the input data and the output data, and respective values of the items are registered.

Next, the data input unit 21 checks if at least either a condition that “the output data has been detected to be abnormal” or a condition that “the rarity of the input data is high” is met (step S107). The output data is detected to be abnormal, for example, in a case where the output data is extremely different as compared with other output data or in a case where the output data exceeds a predetermined threshold. The rarity of the input data can be calculated from comparison with other input data, and the input data is determined to be high in rarity, for example, in a case where its rarity exceeds a predetermined threshold. The detection of the abnormality of the output data and the determination of the rarity of the input data are realized by a general programming process.

In a case where at least either of the above conditions is met in step S107 (YES in step S107), it can be determined that this input data is data having singularity and is data highly likely to be used in the subsequent training process (i.e., having a high likelihood of being used in retraining). Thus, the data input unit 21 registers the input data in the retraining likelihood management table 33 (step S108), and then, ends the data input process. In step S108, in the retraining likelihood management table 33, a record is newly created with respect to the input data, and respective values of the items are registered.

On the other hand, in a case where neither of the above conditions is met in step S107 (NO in step S107), this input data is unlikely to be used in the subsequent training process; thus, the data input unit 21 ends the data input process without registering the input data in the retraining likelihood management table 33.

(3-3) Training Process

FIG. 12 is a flowchart showing an example of the processing procedure of the training process. The training process shown in FIG. 12 corresponds to the process of step S2 in FIG. 10. Processes in steps S201 to S203 are performed by the user, and processes in step S204 and onward are performed by the training processing unit 22.

According to FIG. 12, first, the user causes the display device 3 to display the monitoring screen 110, checks the accuracy of output data on the monitoring screen 110 (step S201), and determines whether or not the accuracy of the data is poor (step S202). The criterion of determination in step S202 may be entrusted to the user, or a predetermined determination criterion may be provided in advance. In a case where the accuracy of the data is not poor in step S202 (NO in step S202), it can be determined that retraining of the model does not have to be performed; thus, the user ends the training process.

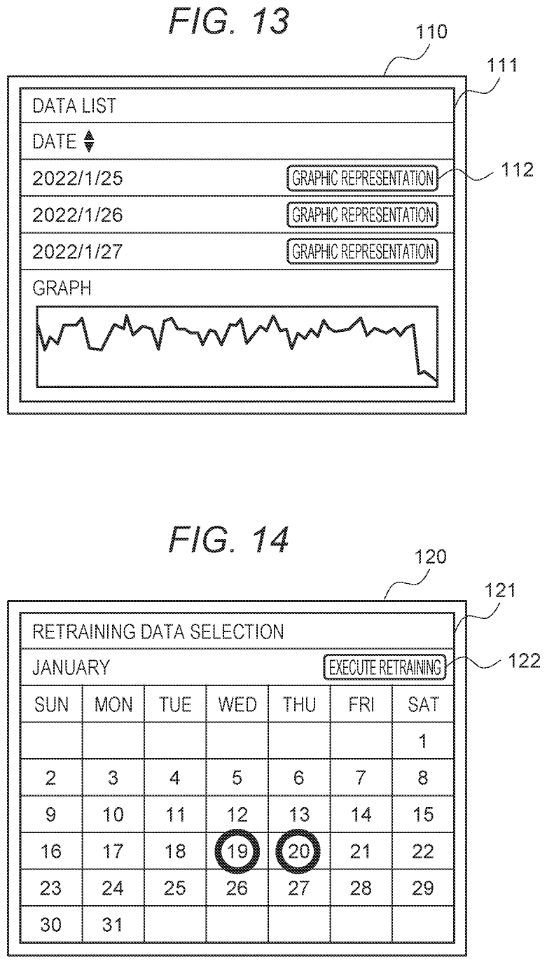

FIG. 13 is a diagram showing an example of the monitoring screen 110. The monitoring screen 110 is a screen that provides a display by which the user can check the accuracy of input/output data of a model for each predetermined unit period (for example, one day), and is generated by the information display unit 26 and displayed on the display device 3.

In a case of the monitoring screen 110 shown in FIG. 13, dates of data that can be checked are shown on a data list section 111, and when a graphic representation button 112 corresponding to any date is pressed by a user operation, data on the date is displayed in the form of a graph. Therefore, the user can check graphic representation of output data and determine whether or not the accuracy of the data is poor.

To return to the description of FIG. 12. In a case where it is determined in step S202 that the accuracy of the data is poor (YES in step S202), the user performs a predetermined operation to display the retraining screen 120, and selects the date of data to be used in retraining of the model through the retraining screen 120 (step S203).

FIG. 14 is a diagram showing an example of the retraining screen 120. The retraining screen 120 is a screen displayed when retraining of a model is performed, and is generated by the information display unit 26 and displayed on the display device 3.

In a case of the retraining screen 120 shown in FIG. 14, dates of data (input data) to be used in retraining of a model are selectably displayed on a retraining data selection section 121, and the user presses a retraining execution button 122 after selecting a desired date, thereby retraining of the model using data of the selected date is initiated (step S204). Specifically, in the case of FIG. 14, “January 19” and “January 20” are selected as the dates of data to be used in retraining.

To return to the description of FIG. 12. After the date is selected in step S203, the training processing unit 22 retrains the model using data (input data) of the selected date and generates a new model (step S204). At this time, a data ID of the input data is acquired by reference to the data management table 31. Furthermore, a new model version is assigned to the generated model.

Next, the training processing unit 22 registers the input data (in other words, the data of the date selected in step S203) used in the generation of the model in step S204 in the training process management table 37 (step S205).

Next, the training processing unit 22 acquires the flag ID 321 of “retraining likelihood” from the flag importance management table 32 (step S206). Specifically, according to the flag importance management table 32 of FIG. 3, the flag ID “F0001” is acquired.

Next, the training processing unit 22 checks whether or not data (a record) corresponding to a combination of the data ID acquired in step S204 and the flag ID acquired in step S206 has been registered in the retraining likelihood management table 33 (step S207).

In a case where data corresponding to the conditions has been registered in the retraining likelihood management table 33 in step S207 (YES in step S207), it means that already-registered data (retraining likelihood data) in the retraining likelihood management table 33 has been used in the retraining in step S204; thus, the training processing unit 22 deletes the record of the data from the retraining likelihood management table 33 (step S208). Then, the training processing unit 22 registers the data with the data ID acquired in step S204 in the retraining likelihood history management table 34 (step S209), and ends the training process.

On the other hand, in a case where data corresponding to the conditions has not been registered in the retraining likelihood management table 33 in step S207 (NO in step S207), already-registered data (retraining likelihood data) in the retraining likelihood management table 33 has not been used in the retraining in step S204, and does not meet the condition to delete its record from the retraining likelihood management table 33. Therefore, in this case, the training processing unit 22 ends the training process.

The training process is performed as described above, thereby it becomes possible to select high-accuracy data having a likelihood of retraining and perform training of the model and also possible to register the data used in the retraining in the training process management table 37 and assign the data the flag “F0005” of “training process”. Furthermore, in a case where already-registered data in the retraining likelihood management table 33 has been used in retraining, it is possible to delete the registration of the data from the retraining likelihood management table 33 and also possible to register the data in the retraining likelihood history management table 34 and assign the data the flag “F0002” of “retraining likelihood history”.

It is noted that steps S206 and S207 may be swapped in the processing order, and steps S208 and S209 may also be swapped in the processing order.

(3-4) Evaluation Process

FIG. 15 is a flowchart showing an example of the processing procedure of the evaluation process. The evaluation process shown in FIG. 15 corresponds to the process of step S3 in FIG. 10. A process in step S301 is performed by the user, and processes in step S302 and onward are performed by the evaluation processing unit 23.

According to FIG. 15, first, the user displays the evaluation screen 130 and selects data to be used in evaluation of the model (step S301).

FIG. 16 is a diagram showing an example of the evaluation screen 130. The evaluation screen 130 is a screen through which input/output data to be used in evaluation can be selected to perform evaluation for checking output data from a new model.

In a case of the evaluation screen 130 shown in FIG. 16, a period of data to be evaluated that can be selected is shown on a data list section 131, and when a graphic representation button 132 corresponding to any period is pressed by a user operation, an evaluation process in step S302 is performed using input/output data of the selected period (dates). After completion of this evaluation process, output data generated in the evaluation is displayed on a graph section 133. For evaluation, output data of a selected period (dates) may also be displayed on the graph section 133. The user can check the accuracy of the data from this graph display. In a case where the accuracy of the data is excellent, the user presses a model update button 134, thereby updating to a model to be used at the time of data input hereafter (step S401 in FIG. 17 to be described later).

To return to the description of FIG. 15. When input data to be used in evaluation has been selected in step S301, the evaluation processing unit 23 performs an evaluation process (step S302). In the evaluation process of step S302, specifically, the evaluation processing unit 23 inputs input data of the dates selected through the evaluation screen 130 to the new model generated in the training process (step S204 in FIG. 12) and generates output data. As described with reference to FIG. 16, the generated output data is graphically displayed in the graph section 133 of the evaluation screen 130, and the user checks the accuracy of the data and presses the model update button 134 if the accuracy is excellent, thereby the data related to the evaluation process of step S302 goes into a selected state.

Next, the evaluation processing unit 23 stores the input data of the dates selected through the evaluation screen 130 (i.e., the data used as input data in the evaluation process of step S302) and the output data generated in the evaluation process in the data management table 31 (step S303). The storage of these input/output data in the data management table 31 is performed by a similar procedure to step S301 in FIG. 11; however, the model version of the model generated in step S204 in FIG. 12 is registered in a value of the item of model version 315.

Next, the evaluation processing unit 23 registers the input data of the dates selected through the evaluation screen 130 (i.e., the data used as input data in the evaluation process of step S302) and the output data generated in the evaluation process management table 38 (step S304). In other words, in step S304, the evaluation processing unit 23 registers the data stored in the data management table 31 in step S303 in the evaluation process management table 38 as well. At this time, in the evaluation process management table 38, with respect to each of input data or output data to be registered, a record is newly created with an evaluation process ID 381 assigned. The flag ID “F0006” corresponding to “evaluation process” is registered in the flag ID 382 (see the flag importance management table 32), and a data ID of the target data is registered in the data ID 383 with reference to the data ID 311 of the data management table 31. Furthermore, the date and time at the moment is registered in the registration date and time 384.

The evaluation process of FIG. 15 is performed as described above, thereby, with respect to the new model regenerated in the training process, evaluation of the new model can be performed by checking the accuracy of the output data in a case of using the input data selected by the user. Then, as a result of the evaluation, in a case where it is determined that the accuracy is excellent, the input/output data can be stored in the data management table 31 and assigned the flag ID “F0006” of “evaluation process”.

It is noted that with respect to the new model regenerated in the training process, in a case where it is determined as a result of the evaluation process of FIG. 15 that the accuracy of the data is poor, a model update process to be described later may be skipped, and the transition to a data management process may be made. Alternatively, as another processing procedure, returning to the training process described above, different data from the previous one may be selected as data to be used in retraining through the retraining screen 120, and reevaluation may be performed using a result of the retraining in an evaluation process.

(3-5) Model Update Process

FIG. 17 is a flowchart showing an example of the processing procedure of the model update process. The model update process shown in FIG. 17 corresponds to the process of step S4 in FIG. 10, and is performed by the model update processing unit 24. The model update process is a process for updating to a model to be used hereafter for machine learning in a case where it is determined in the above-described evaluation process that the accuracy of the new model generated in the training process is excellent.

According to FIG. 17, first, in a case where the model update button 134 on the evaluation screen 130 has been pressed, the model update processing unit 24 updates to the new model generated in the training process (step S204 in FIG. 12) as a model to be used hereafter for machine learning (step S401). Specifically, for example, the model update processing unit 24 adds and stores the new model into a model storage unit (not shown), and sets it so as to be treated as a model to be used for machine learning. At this time, an old version (strictly, a version other than the version of the newly generated model; the same applies hereinafter) of the model may be kept in the model storage unit.

Next, the model update processing unit 24 registers the input data of the date used in the previous evaluation process and the output data generated from the new model updated in step S401 (i.e., the output data generated in step S302 of the evaluation process) in the monitoring screen management table 35 (step S402). The procedure of registering input/output data in the monitoring screen management table 35 is similar to step S106 in FIG. 11.

Next, with reference to the data management table 31, the model update processing unit 24 searches for data (an old version of data) having a model version different from the model version of the data registered on the same date (period) as the data registered in the monitoring screen management table 35 in step S402, and acquires a data ID 311 of corresponding data (step S403).

Next, with reference to the flag importance management table 32, the model update processing unit 24 acquires a flag ID 321 corresponding to “monitoring screen” (“F0003” in this example) (step S404).

Next, the model update processing unit 24 checks whether data (a record) corresponding to a combination of the data ID acquired in step S403 and the flag ID acquired in step S404 has been registered in the monitoring screen management table 35 (step S405).

In a case where data corresponding to the condition has been registered in the monitoring screen management table 35 in step S405 (YES in step S405), it means that aside from the data associated with the new model version registered in step S402, data associated with an old model version has been registered in the monitoring screen management table 35. Therefore, in this case, the model update processing unit 24 registers the data with the data ID acquired in step S403 in the monitoring screen history management table 36 (step S406), and deletes a record of the data from the monitoring screen management table 35 (step S407). Through the processes of steps S406 and S407, the data associated with the old model version is deleted from the monitoring screen management table 35 and registered in the monitoring screen history management table 36, and the data is assigned the flag ID “F0004” corresponding to “monitoring screen history” instead of the flag ID “F0003” corresponding to “monitoring screen”. After the process of step S407, the model update processing unit 24 ends the model update process.

On the other hand, in a case where data corresponding to the condition has not been registered in the monitoring screen management table 35 in step S405 (NO in step S405), the data associated with the old model version has not been registered in the monitoring screen management table 35, and there is no data associated with a different model version on the same date in the monitoring screen management table 35. Therefore, in this case, the model update processing unit 24 ends the model update process without performing the above-described processes of steps S406 and S407.

It is noted that steps S406 and S407 may be swapped in the processing order.

(3-6) Data Management Process

FIG. 18 is a flowchart showing an example of the processing procedure of the data management process. The data management process shown in FIG. 18 corresponds to the process of step S5 in FIG. 10, and is performed by the data management unit 25. The data management process is a process of calculating the importance of each data on the basis of a flag assigned to the data in the foregoing processes, determining whether or not deletion of the data is recommended (deletion recommendation) on the basis of this importance, and registering results of the calculation and the determination in the data management table 31.

According to FIG. 18, first, the data management unit 25 acquires records one at a time from the data management table 31 and starts processes of loop 1 (steps S502 to S511) (step S501). In the following description, the record acquired in step S501 is referred to as “the record”.

In the processes of loop 1, first, the data management unit 25 acquires a data ID 311 of the record (step S502). Further, the data management unit 25 sets the value of importance 316 of the record to “0” (Step S503). It is noted that the process of step S503 is a process for resetting the importance, and is not necessarily limited to resetting the value to “0”.

Next, the data management unit 25 acquires records one at a time from the flag importance management table 32, and starts processes of loop 2 (steps S505 to S508) (step S504). As described above, each record of the flag importance management table 32 manages a flag assigned to data and its importance in each of predetermined processes in the life cycle of machine learning.

In the processes of loop 2, first, the data management unit 25 acquires a flag ID 321 from the record of the flag importance management table 32 acquired in step S504 (step S505).

Next, the data management unit 25 checks whether data with the data ID acquired in step S502 has been registered in the management table (specifically, any of the retraining likelihood management table 33, the retraining likelihood history management table 34, the monitoring screen management table 35, the monitoring screen history management table 36, the training process management table 37, and the evaluation process management table 38) that manages a flag corresponding to the flag ID 321 acquired in step S505 (step S506).

In a case where the condition is not met in step S506 (NO in step S506), the data management unit 25 checks whether the condition for terminating loop 2 is met (whether the processes have completed with respect to all the records of the flag importance management table 32), and, in a case where the condition is not met, returning to step S504, repeats the processes of loop 2. In a case where the condition for terminating loop 2 is met, the data management unit 25 proceeds to step S509.

On the other hand, in a case where the condition is met in step S506 (YES in step S506), the data management unit 25 acquires importance 323 of the flag ID 321 acquired in step S505 from the data management table 31 (step S507), and adds the acquired importance to the importance of the data ID acquired in step S502 (step S508). The data management unit 25 temporarily stores the importance after the addition of the respective degrees, and, in a case where the condition for terminating loop 2 is met, registers the final importance after the addition of the respective degrees in importance 316 of a record that manages the data ID in the data management table 31. Alternatively, each time the importance is added in step S508, the data management unit 25 may update the importance 316 of the record that manages the data ID in the data management table 31 with the importance after the addition of the respective degrees. After that, the data management unit 25 checks whether the condition for terminating loop 2 is met, and, in a case where the condition is not met, returning to step S504, repeats the processes of loop 2. In a case where the condition for terminating loop 2 is met, the data management unit 25 proceeds to step S509.

By repeating the processes of loop 2 as many times as the number of records of the flag importance management table 32 as described above, the total value of respective degrees of importance of flags assigned to data indicated by a data ID acquired in step S502 is registered in the importance 316 of a record corresponding to the data ID in the data management table 31.

After breaking the processes of loop 2, the data management unit 25 determines whether or not the importance of the data calculated through the processes of loop 2 is equal to or lower than a predetermined threshold (step S509). The predetermined threshold may be set in the system in advance, or may be arbitrarily able to be changed by the user.

In a case where the importance of the data is equal to or lower than the threshold in step S509 (YES in step S509), the importance of the data is low, thus the data management unit 25 registers “1” indicating that deletion is recommended in deletion recommendation 317 of the record that manages the data in the data management table 31 (step S510). On the other hand, in a case where the importance of the data exceeds the threshold in step S509 (NO in step S509), the importance of the data is high, thus the data management unit 25 registers “0” indicating that deletion is not recommended in deletion recommendation 317 of the record that manages the data in the data management table 31 (step S511).

After the process of step S510 or S511 is finished, the data management unit 25 checks whether the condition for terminating loop 1 is met (whether the processes have completed with respect to all the records of the data management table 31), and, in a case where the condition is not met, returning to step S501, repeats the processes of loop 1. In a case where the condition for terminating loop 1 is met, the data management unit 25 ends the data management process.

By repeating the processes of loop 1 as many times as the number of records of the data management table 31 as described above, “1” as for data having a low impact if deleted or “0” as for data having a high impact if deleted is registered in deletion recommendation 317 of each record of the data management table 31. As a result, it is possible to distinguish the advisability of deletion recommendation of each data by the value of the deletion recommendation 317 of the data management table 31.

(3-7) Result Display Process

FIG. 19 is a flowchart showing an example of the processing procedure of the result display process. The result display process shown in FIG. 19 corresponds to the process of step S6 in FIG. 10, and is performed by the information display unit 26.

According to FIG. 19, first, the information display unit 26 acquires records one at a time from the data management table 31 and starts processes of loop 1 (steps S602 to S609) (step S601). In the following description, the record acquired in step S601 is referred to as “the record”.

In the processes of loop 1, first, the information display unit 26 acquires deletion recommendation 317 of the record (step S602), and determines whether or not its value is “1” indicating that deletion is recommended (step S603).

In a case where the value of the deletion recommendation 317 is other than “1”, i.e., “0” in step S603 (NO in step S603), the information display unit 26 checks whether the condition for terminating loop 1 is met (whether the processes have completed with respect to all the records of the data management table 31), and, in a case where the condition is not met, returning to step S602, repeats the processes of loop 1. In a case where the condition for terminating loop 1 is met, the information display unit 26 proceeds to step S610 to be described later.

On the other hand, in a case where the value of the deletion recommendation 317 is “1” in step S603 (YES in step S603), the information display unit 26 acquires a data ID 311 of the record (step S604).

Next, the information display unit 26 acquires records one at a time from the flag importance management table 32, and starts processes of loop 2 (steps S606 to S608) (step S605).

In the processes of loop 2, first, the information display unit 26 acquires a flag ID 321 from the record of the flag importance management table 32 acquired in step S605 (step S606).

Next, the information display unit 26 checks whether data with the data ID acquired in step S604 has been registered in the management table (specifically, any of the retraining likelihood management table 33, the retraining likelihood history management table 34, the monitoring screen management table 35, the monitoring screen history management table 36, the training process management table 37, and the evaluation process management table 38) that manages a flag corresponding to the flag ID 321 acquired in step S606 (step S607).

In a case where the condition is not met in step S607 (NO in step S607), the information display unit 26 checks whether the condition for terminating loop 2 is met (whether the processes have completed with respect to all the records of the flag importance management table 32), and, in a case where the condition is not met, returning to step S605, repeats the processes of loop 2. In a case where the condition for terminating loop 2 is met, the information display unit 26 proceeds to step S609.

On the other hand, in a case where the condition is met in step S607 (YES in step S607), the information display unit 26 acquires record information of the data from the management table that manages the flag corresponding to the flag ID 321 acquired in step S606 (step S608). Specifically, for example, the information display unit 26 checks whether there is the data in the monitoring screen history management table 36 on the basis of the flag ID, and, in a case where the acquired data ID has been registered, acquires information (a monitoring screen history ID 361, a flag ID 362, a data ID 363, and a use period 364) of a corresponding record. After that, the information display unit 26 checks whether the condition for terminating loop 2 is met, and, in a case where the condition is not met, returning to step S605, repeats the processes of loop 2. In a case where the condition for terminating loop 2 is met, the information display unit 26 proceeds to step S609.

By repeating the processes of loop 2 as many times as the number of records of the flag importance management table 32 as described above, the information display unit 26 can acquire, with respect to data of which the deletion is recommended in the data management table 31, a flag assigned to the data in each management table and a list of information related to the flag.

After breaking the processes of loop 2, the information display unit 26 acquires information (specifically, a data ID 311, a date 312, data 313, a data type 314, a model version 315, importance 316, and deletion recommendation 317) of the record corresponding to the data ID acquired in step S604 from the data management table 31 (step S609).

After that, the information display unit 26 checks whether the condition for terminating loop 1 is met (whether the processes have completed with respect to all the records of the data management table 31), and, in a case where the condition is not met, returning to step S601, repeats the processes of loop 1. In a case where the condition for terminating loop 1 is met, the information display unit 26 proceeds to step S610.

By repeating the processes of loop 1 as many times as the number of records of the data management table 31 as described above, the information display unit 26 can acquire, with respect to data determined that its deletion is recommended, various information including its additional information.

Last, the information display unit 26 creates the data management result screen 140 formed in a predetermined form of display using the information acquired through the foregoing steps, causes the display device 3 to display the created data management result screen 140 (step S610), and ends the result display process.

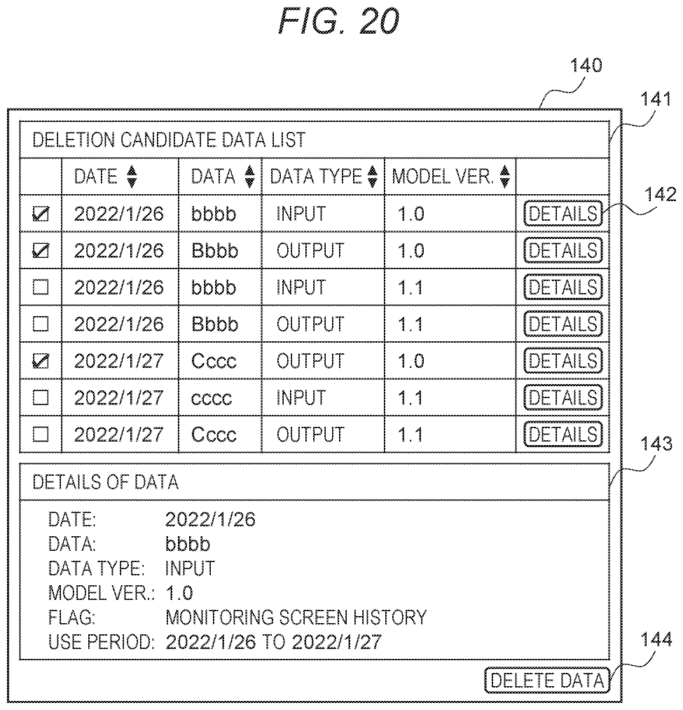

FIG. 20 is a diagram showing an example of the data management result screen 140. The data management result screen 140 is a screen that displays thereon a list of data of which the deletion is recommended (deletion candidate data) and can display thereon detailed additional information of the data.

In a case of the data management result screen 140 shown in FIG. 20, a list of input/output data that a value of “1” has been registered in deletion recommendation 317 of the data management table 31 is displayed in a deletion candidate data list section 141. The user checks this deletion candidate data list section 141, and thereby can recognize which data is data having a low impact if deleted. In FIG. 20, with respect to each data, additional information such as a date, data, a data type, and a model version is displayed in the deletion candidate data list section 141; however, these are values of some of the items of the data management table 31 displayed. In a case where the user wants to check more detailed additional information of the data, the user presses a details button 142, and information of each item acquired from the data management table 31 and processing of a flag assigned to the data (“monitoring screen history” in the example of FIG. 20) are displayed as detailed additional information of the selected data in a details of data section 143.

In a case where the user wants to delete some of the data after checking the data management result screen 140, the user ticks a box for the data he/she wants to delete in the deletion candidate data list section 141, and presses a data deletion button 144. When an operation to press the data deletion button 144 has been made, the data management system 1 (for example, the data management unit 25) deletes a record that manages the data with a tick mark from the data management table 31. Furthermore, at this time, the record of the target data is also deleted from the table that manages the flag assigned to the target data.

As a result, the data management system 1 can delete input/output data that has been determined to have a low impact if deleted and on which the user, too, has made a final judgment that it can be deleted from the system. Thus, in the data management system 1, it is possible to efficiently operate deletion of unnecessary data while the life cycle of machine learning rotates, and it is possible to realize log rotation in which only necessary data remains. Then, the amount of data held by the system can be appropriately reduced, and therefore, an effect of suppressing the running cost can be obtained.

It is noted that in the above description, the user looks at the data management result screen 140 and makes a final judgment of whether or not the data determined that its deletion is recommended is actually deleted; however, a program (for example, the data management unit 25) may be configured to automatically perform a process of deleting the data determined that its deletion is recommended. Besides this, for example, it may be configured to provide a grace period until deletion of the data determined that its deletion is recommended, and inform the user that it is during the grace period, and then delete the data after the grace period.

(4) Modification Example

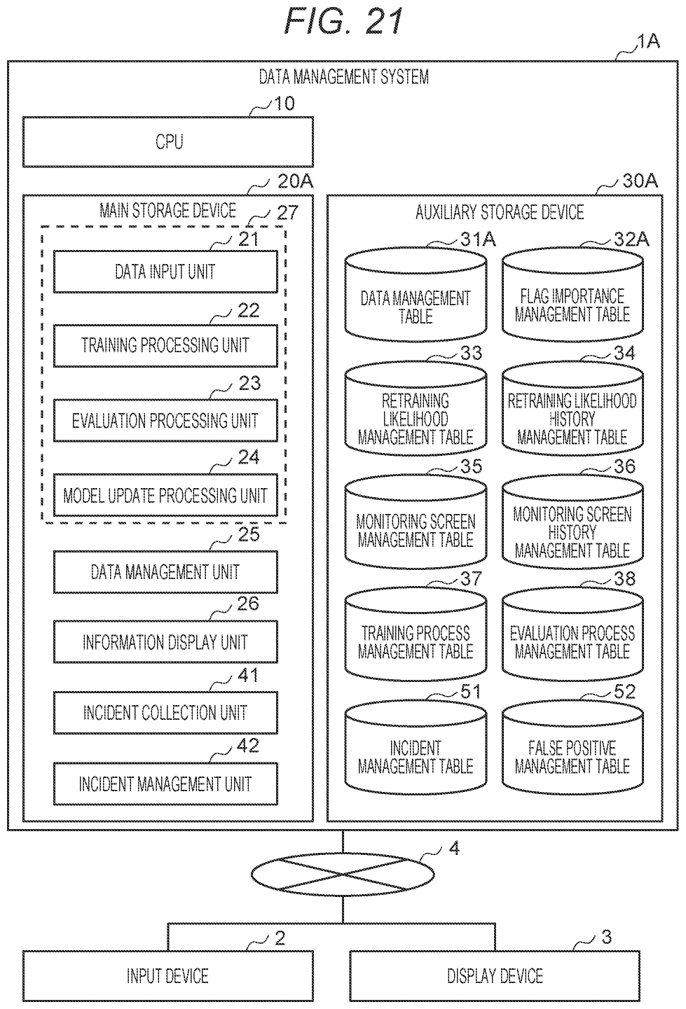

FIG. 21 is a block diagram showing a configuration example of a data management system 1A that is a modification example of the data management system 1. In the data management system 1A, a similar component to that of the data management system 1 described with reference to FIG. 1, etc. is assigned the same reference numeral, and description of the component is omitted. Furthermore, a partly different component from that of the data management system 1 is expressed by the same reference numeral and an additional character A, and the different part is mainly described.

As described in the description of the data management system 1, output data output from a model may include, for example, abnormal data detected to be abnormal by the model. In the data management system 1, output data detected to be abnormal is determined to be data having a likelihood of retraining and is assigned a retraining likelihood flag; however, there is possibility that such abnormal data may actually be normal data (hereinafter, also referred to as “false positive data”). In a data management system that manages input/output data in a model of machine learning, input data of a model that has generated such false positive data is identified and utilized for parameter adjustment, etc., which can help improve the model. Accordingly, the data management system 1A pays attention to, of output data generated from a model, output data detected to be abnormal (abnormal data), and, in keeping with user's determination (incident response) of whether or not this abnormality detection is false positive, extracts input data of the model that has generated abnormal data determined to be false positive (false positive data), thereby realizing effective input/output data management. It is noted that such input data is also referred to as “input data corresponding to false positive data”. Characteristic configurations, processes, etc. of the data management system 1A will be described in detail below.

As shown in FIG. 21, the data management system 1A includes an incident collection unit 41 and an incident management unit 42 as a functional unit implemented by a processor (the CPU 10) reading a program into a main storage device 20A (a memory) and executing the program. Furthermore, the data management system 1A includes an incident management table 51 and a false positive management table 52 as a management table held by an auxiliary storage device 30A to store predetermined data therein. The incident collection unit 41, the incident management unit 42, the incident management table 51, and the false positive management table 52 are components unique to the data management system 1A. Moreover, the data management system 1A includes a data management table 31A and a flag importance management table 32A as a management table whose data formation is partly different from the management table held by the data management system 1.

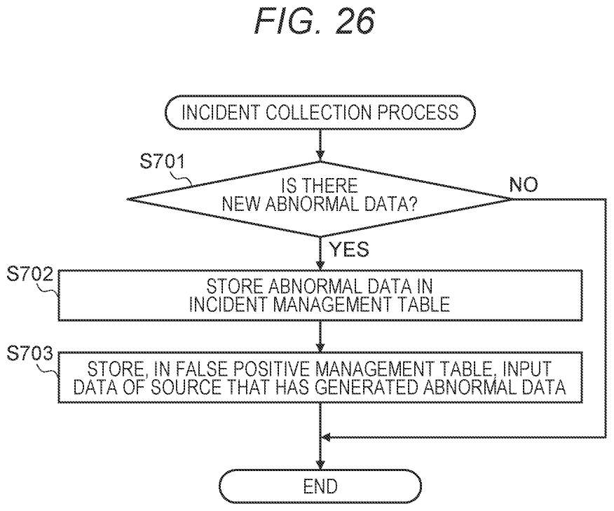

The incident collection unit 41 has a function of collecting input/output data to be managed as an incident in model generation and storing the collected data in the incident management table 41 or the false positive management table 52. A process performed by the incident collection unit 41 will be described in detail with reference to an incident collection process shown in FIG. 26 to be described later.

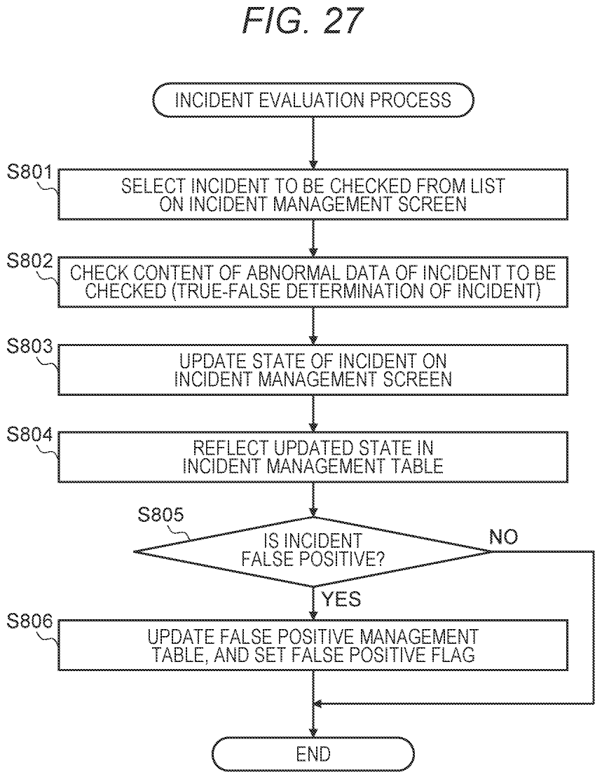

The incident management unit 42 has a function of, with respect to data of an incident collected by the incident collection unit 41, updating the incident management table 51 and the false positive management table 52 according to an incident response of the user who determines whether output data detected to be abnormal (abnormal data) is false positive. A process performed by the incident management unit 42 will be described in detail with reference to an incident evaluation process shown in FIG. 27 to be described later.

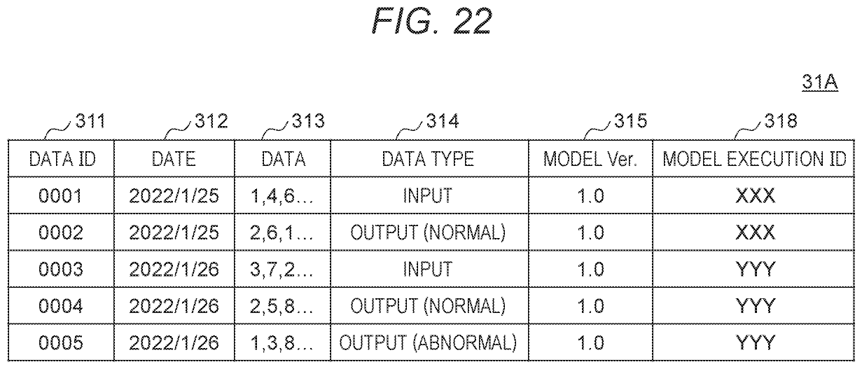

FIG. 22 is a diagram showing an example of the data management table 31A. The data management table 31A shown in FIG. 22 includes an item of model execution ID 318, which is different from the data management table 31 shown in FIG. 2. The model execution ID 318 indicates an identifier (a model execution ID) assigned to a combination of input data and output data of a model. The model execution ID is assigned by the data management unit 25 or the operation unit 27. Furthermore, in a case where target data is output data, information indicating whether the output data is normal or abnormal is added in data type 314 of the data management table 31A. Specifically, data with “output (normal)” in the data type 314 means the data is normal output data that has not been detected to be abnormal when generated by a model, and data with “output (abnormal)” in the data type 314 means the data is abnormal output data (abnormal data) that has been detected to be abnormal when generated by a model.

It is noted that although not shown in FIG. 22, the data management table 31A may include the items of importance 316 and deletion recommendation 317 as with the data management table 31 shown in FIG. 2, and may include other items.

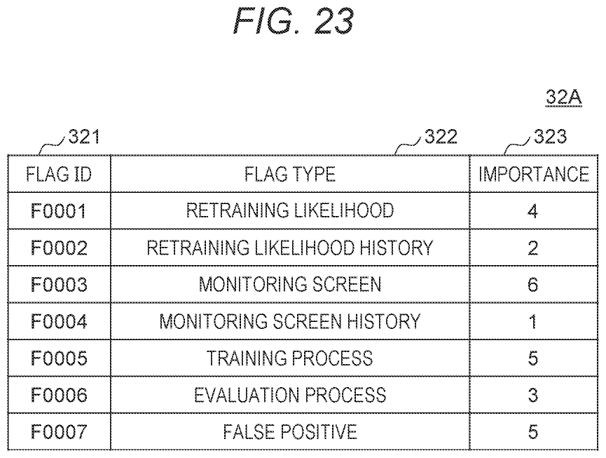

FIG. 23 is a diagram showing an example of the flag importance management table 32A. In the flag importance management table 32A shown in FIG. 23, information regarding a “false positive” flag is added, which is different from the flag importance management table 32 shown in FIG. 3. The “false positive” flag is a flag assigned to input data corresponding to false positive data, and, in FIG. 23, flag ID “F0007” and a degree of importance of “5” are set.

It is noted that a degree of importance of “5” of the false positive flag shown in FIG. 23 is an example, and it is not limited to this. However, the false positive flag is preferably set a higher degree of importance (i.e., a degree of importance of “3” or higher) than a flag assigned to data used in the past (specifically, in FIG. 23, the “retraining likelihood history” flag with flag ID “F0002” assigned to input data used in retraining and the “monitoring screen history” flag with flag ID “F0004” assigned to input/output data used in display on the monitoring screen 110).

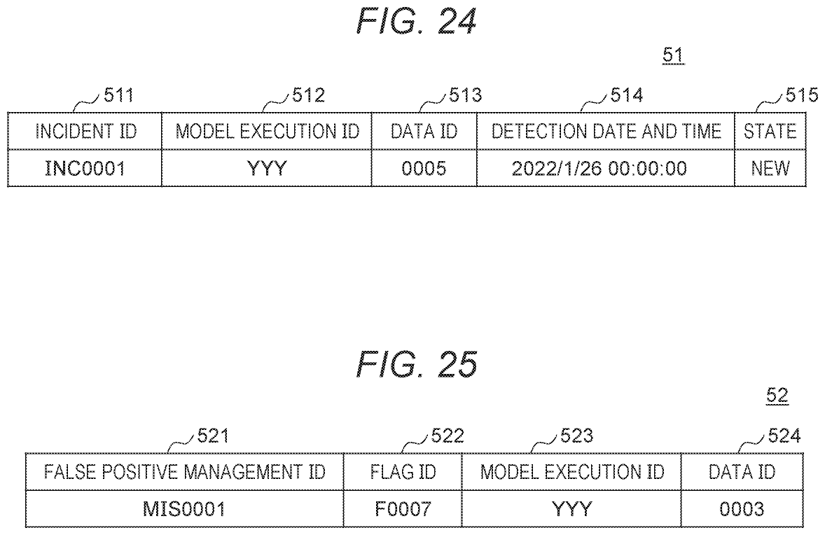

FIG. 24 is a diagram showing an example of the incident management table 51. The incident management table 51 is a table in which data is registered by the incident collection unit 41 through the incident collection process, and manages information regarding output data (abnormal data) detected to be abnormal. As described above in the description of FIG. 22, abnormal data is data of which the data type 314 is “output (abnormal)” (in a case of FIG. 22, data with data ID “0005”), and a part of information regarding abnormal data can be acquired from the data management table 31A.

The incident management table 51 shown in FIG. 24 includes items of incident ID 511, model execution ID 512, data ID 513, detection date and time 514, and state 515.

The incident ID 511 indicates an identifier (an incident ID) assigned to each abnormal data when registered in the incident management table 51. The model execution ID 512 indicates a model execution ID of abnormal data managed in a corresponding record. The model execution ID 512 corresponds to the model execution ID 318 of the data management table 31A. The data ID 513 indicates a data ID of abnormal data managed in a corresponding record. The data ID 513 corresponds to the data ID 311 of the data management table 31A. The detection date and time 514 indicates the date and time of when abnormal data managed in a corresponding record has been detected to be abnormal by a model. The detection date and time 514 corresponds to the date 312 of the data management table 31A; however, it may hold more detailed information than the date 312.

The state 515 indicates a state of an incident response to abnormal data managed in a corresponding record. The state 515 is, for example, any one selected from several types of status prepared in advance (it may be configured to be able to add or delete any status to/from the several types of status). Specifically, examples of the several types of status include: “new” set at the time of new registration to the incident management table 51; “on hold” set in a case where the user puts an incident response on hold; “in progress” set in a case where the user is working on an incident response; “completed” set in a case where the user has determined that it is not false positive and completed an incident response; and “false positive” set in a case where the user has determined that it is false positive and completed an incident response. It is noted that the above-described types of status are an example, and the type of status is not limited to these; however, it is preferable that at least two or more types of status indicating whether or not it is “false positive” be prepared.

FIG. 25 is a diagram showing an example of the false positive management table 52. The false positive management table 52 is a table in which data is registered or updated by the incident collection unit 41 or the incident management unit 42 through the incident collection process and the incident evaluation process, and manages information regarding input data corresponding to false positive data determined to be false positive in an incident response by the user.

The false positive management table 52 shown in FIG. 25 includes items of false positive management ID 521, flag ID 522, model execution ID 523, and data ID 524.

The false positive management ID 521 indicates an identifier (a false positive management ID) assigned to each input data (input data corresponding to false positive data) when registered in the false positive management table 52. The flag ID 522 indicates a flag ID of input data managed in a corresponding record. The flag ID 522 corresponds to the flag ID 321 of the flag importance management table 32A, and input data corresponding to false positive data is assigned flag ID “F0007”. The model execution ID 523 indicates a model execution ID of input data managed in a corresponding record. The model execution ID 523 corresponds to the model execution ID 318 of the data management table 31A. The data ID 524 indicates a data ID of input data managed in a corresponding record. The data ID 524 corresponds to the data ID 311 of the data management table 31A.

FIG. 26 is a flowchart showing an example of the processing procedure of the incident collection process. The incident collection process shown in FIG. 26 is performed by the incident collection unit 41. The incident collection process can be performed regularly or irregularly at any timing after the data input process (FIG. 11) is performed, and may be started, for example, by the user or someone operating a predetermined user interface, or may be started by automatic processing using a batch program or the like.

According to FIG. 26, first, the incident collection unit 41 determines whether or not there is new abnormal data with reference to the data management table 31A (step S701). In step S701, the incident collection unit 41 can determine the presence or absence of new data by comparing, for example, the last execution date and time the incident collection process has been executed last time with the date 312 of the data stored in the data management table 31A. Furthermore, in a case where in such new data, there is data of which the data type 314 of the data stored in the data management table 31A is “output (abnormal)”, the incident collection unit 41 can determine that the data is “new abnormal data”. In a case where there is new abnormal data (YES in step S701), the process moves on to step S702; on the other hand, in a case where there is no new abnormal data (NO in step S701), the incident collection process ends.

In step S702, the incident collection unit 41 stores predetermined information regarding the new abnormal data found in step S701 in the incident management table 51. In the process of step S702, specifically, a new record is created in the incident management table 51, and a variety of information is registered in this new record. At this time, “new” is set in the state 515 of the new record.

Next, the incident collection unit 41 stores predetermined information regarding the input data corresponding to the abnormal data registered in the incident management table 51 in step S702 (i.e., the input data of the time when the model has output the abnormal data) in the false positive management table 52. Specifically, in step S703, with reference to the data management table 31A, the incident collection unit 41 searches for input data having the same model execution ID 318 as the model execution ID 512 of the abnormal data newly registered in the incident management table 51 in step S702, and acquires information regarding the corresponding input data and registers the information in the new record of the false positive management table 52. At this time, the value of the flag ID 522 of the new record may be unregistered. After the process of step S703 is finished, the incident collection unit 41 ends the incident collection process.

FIG. 27 is a flowchart showing an example of the processing procedure of the incident evaluation process. The incident evaluation process shown in FIG. 27 is a process performed after the incident collection process shown in FIG. 26, and processes of steps S801 to S803 are performed by the user who makes an incident response, and processes of steps S804 to S806 are performed by the incident management unit 42.

According to FIG. 27, first, the user operates the data management system 1A or a user terminal (not shown) to open an incident management screen on which information stored in the incident management table 51 is visually displayed, and performs an operation to select abnormal data (an incident to be checked) that the user wants to check in the incident response at this time from a list of abnormal data displayed on the incident management screen (step S801).

The incident management screen is generated, for example, by the information display unit 26 or the incident management unit 42 executing a predetermined program on the basis of the incident management table 51 or various other data, and is displayed on the user side by any output method such as through a user interface. A method of displaying information on the incident management screen is not particularly limited; however, in the description here, as an example, at system startup, a site where the incident has occurred, a model, other reference information, etc. are displayed in the form of a list for each abnormal data.

After the incident to be checked is selected in step S801, predetermined detailed information regarding the selected incident is displayed on the incident management screen. This detailed information may include not only information of the abnormal data stored in the incident management table 51 but also various any other data. For example, the detailed information may include the graph on the monitoring screen 110 shown in FIG. 13 and information corresponding to the displayed content of the data details 143 on the data management result screen 140 shown in FIG. 20. Then, the user checks the content of abnormal data displayed on the incident management screen, and performs true-false determination of if the incident is false positive on the basis of his/her knowledge, etc. (step S802). In other words, the process of step S802 is to determine whether or not the abnormal data is false positive data.

Next, on the basis of a result of the true-false determination in step S802, the user updates the “state” of the incident to be checked on the incident management screen (step S803). This “state” indicates a state of an incident response, and corresponds to any of the types of status prepared for the state 515 of the incident management table 51. Specifically, in a case where a result of the determination in step S803 is “false positive (the incident is false)”, the user updates the “state” of the incident to be checked to “false positive”. On the other hand, in a case where a result of the determination in step S803 is “not false positive (the incident is true)”, the user updates the “state” of the incident to be checked to “completed”. Furthermore, in a case where the true-false determination of the incident is put off in step S803, the user updates the state to “on hold” or “in progress” according to the progress.

After the “state” of the incident is updated on the incident management screen in step S803, the incident management unit 42 updates the state 515 of the corresponding record in the incident management table 51 with the updated “state” (step S804).

Next, the incident management unit 42 determines whether or not a result of the true-false determination of the incident by the user in step S802 is false positive (step S805). Specifically, the incident management unit 42 determines whether or not the state 515 of the incident management table 51 updated in Step S804 is “false positive” (Step S805). In a case where it is “false positive” (YES in step S805), the process moves on to step S806; on the other hand, in a case where it is other than “false positive” (NO in step S805), the incident evaluation process ends.

In step S806, the incident management unit 42 updates the false positive management table 52 pertaining to the input data corresponding to the abnormal data of the incident determined to be “false positive”, and sets a false positive flag. Specifically, in step S806, with the model execution ID 512 of the record in which the state 515 of the incident management table 51 has been updated to “false positive” as a key, the incident management unit 42 searches the model execution ID 523 of the false positive management table 52, and sets the value of the flag ID 522 of the record having the same model execution ID to “F0007”. Then, after step S806 is finished, the incident management unit 42 ends the incident evaluation process.

It is noted that, in the above-described incident evaluation process of FIG. 27, before the user obtains a result of the determination of whether the incident is false positive, information regarding the input data corresponding to the abnormal data is registered in the false positive management table 52 through the process of step S703 of the incident collection process; however, as another example of the processing procedure, information regarding the input data corresponding to the false positive data may be registered in the false positive management table 52 after it is determined that the incident is false positive by an incident response the user.

In this case, specifically, for example, in step S806, the incident management unit 42 notifies the incident collection unit 41 of the value of the model execution ID 512 in the record of the incident management table 51 in which the state 515 has been changed to “false positive” in step S804. Then, with the notified model execution ID as a key, the incident collection unit 41 searches the model execution ID 318 of the data management table 31A, and acquires information regarding input data having the same model execution ID and registers the information in the new record of the false positive management table 52. At this time, the value of the flag ID 522 of the new record is set to “F0007” indicating the false positive flag. The setting of the value of the flag ID 522 may be performed by the incident collection unit 41 at the time of registration of the new record, or may be performed by the incident management unit 42 when having received a notification of the completion of registration of the new record in the false positive management table 52 from the incident collection unit 41. Anyway, in a case where the other example of the processing procedure described above is adopted, the process of step S703 in FIG. 26 is unnecessary.

In a case where the other example of the processing procedure is adopted, information regarding the input data corresponding to the abnormal data determined not to be false positive is not stored in the false positive management table 52; thus, it is possible to reduce the data processing amount and simplify information managed in the false positive management table. Meanwhile, in a case where the examples of the processing procedure shown in FIGS. 26 and 27 are adopted, the incident collection unit 41 and the incident management unit 42 can independently perform the processes; thus, it is possible to reduce the processing load as compared with the other example of processing procedure.

As described above, the data management system 1A performs the incident collection process and the incident evaluation process; thus, with respect to an incident determined to be false positive by the user, a false positive flag can be set in input data (input data that is the source of false positive) that is the source of a model that has generated the output data resulting in the incident, and information regarding the input data can be stored in the false positive management table 52. Then, the data management system 1A can use the input data assigned the false positive flag, for example, as follows.

For example, as first use, the data assigned the false positive flag may be set so as not to be used in retraining. In this case, when the false positive flag is assigned to the input data in step S806 of FIG. 27, the data management unit 25 or some other unit only has to remove the retraining likelihood flag (flag ID “F0001”) assigned to the input data. Specifically, by clearing the flag “F0001” of the input data and deleting the registration of the input data from the retraining likelihood management table 33, it becomes possible to avoid the input data being selected as data used in retraining afterward.

It is noted that if the input data assigned the false positive flag is not abnormal data, and the retraining likelihood flag is removed from the input data, this may affect the calculation of importance of the data. Therefore, in the first use, it may be configured to perform control of avoiding the input data assigned the false positive flag being selected as data used in retraining through the retraining screen 120 (see FIG. 14) without removing the retraining likelihood flag from the input data assigned the false positive flag.

Furthermore, for example, as second use, the input data assigned the false positive flag may be used in the evaluation of a model updated to a new version. In this case, when the new version model has generated output data from the input data assigned the false positive flag, if no abnormality is detected in the output data, it becomes clear that the input data is not the source of the abnormal output data, and it can be determined that the model accuracy is improved.

In this way, the data management system 1A that is a modification example of the data management system 1 can provide the user with information about “input data that is the source of false positive”, and therefore it is possible to realize more efficient data management than the data management system 1.

What is claimed is:

1. A data management system of a machine learning model that manages a model and associated data of the model while operating the model along a life cycle of machine learning, the data management system comprising:
flag management information that manages and defines respective flags corresponding to, of a plurality of processes included in the life cycle, one or more predetermined processes;
an operation unit that operates the model along the life cycle; and
a data management unit that manages input data and output data of the model, wherein
the operation unit assigns flags defined in the flag management information to the input data and the output data of the model in accordance with involvement in the predetermined processes at time of operating the model, and
the data management unit determines, with respect to each of the input data and the output data, necessity of storage of data on a basis of a flag assigned to the data by the operation unit.

2. The data management system according to claim 1, wherein
a degree of importance is set for each of the flags, and
with respect to each of the input data and the output data, the data management unit calculates a degree of importance of data on a basis of the degree of importance of a flag assigned to the data by the operation unit, and, in a case where the calculated degree of importance is equal to or lower than a predetermined threshold, determines that the data is unnecessary data that does not have to be stored.

3. The data management system according to claim 2, wherein
in a case where more than multiple flags are assigned to the input data or the output data, the data management unit sets a sum of respective degrees of importance set in the flags as a degree of importance of the data.

4. The data management system according to claim 1, further comprising an information display unit that outputs a result of determination of the necessity of storage of the data by the data management unit to a display screen, wherein
the data management unit deletes, of unnecessary data that does not have to be stored and is displayed on the display screen, data selected by a user.

5. The data management system according to claim 1, wherein the data management unit automatically deletes data determined to be unnecessary data that does not have to be stored.

6. The data management system according to claim 2, wherein
the flags managed in the flag management information includes at least any of:
a first flag assigned to input data or output data that is used for display of a monitoring screen for monitoring accuracy of data;
a second flag assigned to input data or output data that is no longer used for display of the monitoring screen;
a third flag assigned to input data having a likelihood of being used in retraining of a model;
a fourth flag assigned to input data used in retraining of a model after having been determined to have a likelihood of being used in retraining of the model;
a fifth flag assigned to input data used in training of a model;
a sixth flag assigned to, when output data generated from a newly generated model is evaluated, input data used for generation of the model and the output data generated from the model; and
a seventh flag assigned to, in a case where output data detected to be abnormal by a model is not abnormal, input data that is a source based on which the model has output the output data.

7. The data management system according to claim 6, wherein
a higher degree of importance than respective degrees of importance of the second and fourth flags is set in the first, third, fifth, sixth, and seventh flags.

8. The data management system according to claim 7, wherein
the flags managed in the flag management information includes the third flag, and
the operation unit generates a model using input data, and generates output data from the model, and after that, in a case where an abnormality is detected in the output data or in a case where the input data is determined to be rare, the operation unit assigns the third flag to the input data.

9. The data management system according to claim 8, wherein
the flags managed in the flag management information further includes the fourth and fifth flags, and
in a case where accuracy of output data generated from the generated model, the operation unit performs retraining of generating a new model using, of input data assigned the third flag, input data selected by a user, and, deletes the third flag from and assigns the fourth flag to the input data used in the retraining, and also assigns the fifth flag to the input data used in the retraining.

10. The data management system according to claim 9, wherein
the flags managed in the flag management information further includes the sixth flag, and
the operation unit generates output data by inputting input data for evaluation selected by the user to the newly generated model, and determines accuracy of the output data and thereby evaluates the newly generated model, and assigns the sixth flag to the input data for evaluation and the output data generated by inputting the input data for evaluation.

11. The data management system according to claim 10, wherein
the flags managed in the flag management information further includes the first and second flags, and
in a case where after evaluation of the newly generated model, the model is updated as a model to be used hereafter, the operation unit deletes the first flag from and assigns the second flag to the input data used for generation of the model before update and output data generated from the model before update, and also assigns the first flag to the input data used for generation of the model after update and output data generated from the model after update.

12. A data management method implemented by a data management system of a machine learning model that manages a model and associated data of the model while operating the model along a life cycle of machine learning, the data management system including:
flag management information that manages and defines respective flags corresponding to, of a plurality of processes included in the life cycle, one or more predetermined processes;
an operation unit that operates the model along the life cycle; and
a data management unit that manages input data and output data of the model,
the data management method comprising:
an operation step in which the operation unit assigns flags defined in the flag management information to the input data and the output data of the model in accordance with involvement in the predetermined processes at time of operating the model; and
a necessity determination step in which the data management unit determines, with respect to each of the input data and the output data, necessity of storage of data on a basis of a flag assigned to the data at the operation step.

13. The data management system according to claim 11, further comprising an incident collection unit that collects and accumulates information regarding, of output data of a model, output data detected to be abnormal by the model.

14. The data management system according to claim 13, wherein
the flags managed in the flag management information further includes the seventh flag, and
the data management system further comprises an incident management unit that assigns, in a case where a user has determined that the output data whose information has been accumulated by the incident collection unit is not abnormal, the seventh flag to input data that is a source of the model having generated the output data.
